(19) United States
(12) Patent Application Publication
(10) Pub. No.: US 2010/0122981 A1
(43) Pub. Date: May 20, 2010

(54) SHIPPING CONTAINER SYSTEMS

(75) Inventor: David M. Sims, Houston, TX (US)

Correspondence Address: JEFFREY L. WENDT, PRAMUDJI WENDT & TRAN , LLP, 1800 BERING DRIVE , SUITE 540, HOUSTON, TX, 77057, US

(73) Assignee: Evironmental Packaging Technologies Limited

(21) Appl. No.: 12/616,825

(22) Filed: Nov. 12, 2009

Related U.S. Application Data
(60) Provisional application No. 61/115,794, filed on Nov. 18, 2008.
(60) Provisional application No. 61/215,706, filed on May 8, 2009.

(51) Int. Cl. B65D 88/02; B65D 21/02; B65D 81/26; F16K 27/00; B61D 45/00; B60P 7/135; B60P 7/14; B60P 7/15

(52) U.S. Cl. 220/1.6; 220/23.83; 206/204; 251/366; 410/144; 410/129

(57) ABSTRACT

The application relates to shipping container systems that include a large multi-layered flexible container (“flexitank”) disposed inside a large rigid shipping container which has an open end with one or more doors capable of an open or closed position, and further including one or more bulkhead assemblies, one of the bulkhead assemblies interposed between the flexitank and the open end of the rigid container and/or the doors. In at least one specific embodiment, the bulkhead assembly includes a first brace disposed vertically along a portion of the first side wall inner surface; a second brace disposed vertically along a portion of the second side wall inner surface; and a bulkhead panel member extending horizontally between the first brace and the second brace. In other embodiments, bulkhead assemblies may utilize generally curved or “swept” bulkhead bars, which do not require vertical braces.

### CROSS-REFERENCE TO RELATED APPLICATIONS

This application claims domestic priority benefit under 35 U.S.C. §120 from applicant's provisional patent application Ser. No. 61/115,794, filed Nov. 18, 2008, which is incorporated herein by reference in its entirety, and from applicant's provisional patent application Ser. No. 61/215,706, filed May 8, 2009, also incorporated herein by reference in its entirety.

### BACKGROUND

1. Technical Field

The field of the invention(s) claimed below relates to any shipping container system that includes a large multi-layered flexible container (“flexitank”) disposed inside a large rigid shipping container which has an open end with one or more doors capable of an open or closed position, and further including one or more bulkhead bars or a bulkhead assembly interposed between the flexitank and the open end of the rigid container and/or the doors. Methods of assembling container systems and bulkhead assemblies, and certain bulkhead bars, are also considered within the present disclosure.

2. Description of Related Art

As noted above, the particular type of shipping container apparatus to which this application relates is one that includes a large multi-layered flexible container (“flexitank”) in combination with a large, box-shaped, rigid shipping container. When assembling the apparatus, the initially-empty flexitank is placed inside the rigid container. Typically, reinforcing bars and a woven sheet are then installed to form a barrier between the flexitank and the open end of the rigid container, which also functions as a barrier after the container doors are closed. The installation of the woven sheet typically includes strapping it in place. Cargo, such as liquid or granular material, is then introduced to the inside of the flexitank, typically through a discharge or inlet valve. After the flexitank is filled, the container door(s) are rotated to a closed position. The resulting apparatus is primarily used to transport the cargo for great distances, typically over water, on barges or other types of oceangoing vessels, and also sometimes over land by railway.

Shipping container apparatus having a flexible container placed inside a rigid container have been used before, including several that are identified in one or more patents appearing on the face of this patent. Many of those types of shipping container apparatus in use today suffer from various shortcomings. One shortcoming is the difficulty of proper installation, the labor-intensive nature of installation, and the time required for the installation. Another shortcoming with currently-used shipping apparatus is undue leakage of liquid cargo from the flexible container. This leakage occurs in various places in the flexible container and for various reasons. Leakage may occur in the vicinity of one of the valves, e.g., the discharge valve, or through a hole in the flexitank.

Certain modifications in container apparatus have been proposed and/or implemented, purporting to solve or overcome the leakage problems. These modifications have included changing the construction of the flexible container itself, i.e., the bag(s), and also changing the fittings. For example, changes have been proposed in the structures used to clamp together the various layers of the flexible container. One patent application that discloses changes in the bag(s) and the fittings is the application filed by True and assigned to Environmental Packaging Technologies Limited, U.S. Ser. No. 11/124,982, Publication No. US 2006/0251343 (hereinafter, the “982 application”). Various prior art patents were referenced by the Patent Office in the examination of that application, including Owen (U.S. Pat. No. 2,687,158); Langford (U.S. Pat. No. 2,336,552); LaFleur (U.S. Pat. No. 5,851,072) and Dorsch (U.S. Pat. No. 3,750,730). Those patents also disclose changes in the fittings and/or in the flexible sheets and how they are combined or assembled together.

Many of the shipping container apparatus in use today (which as noted above are defined as having a flexible container (flexitank) placed inside a rigid shipping container) also include a structure placed between the flexitank and the rigid shipping container door(s), discussed below. Certain shipping container apparatus include a plurality of straight (not curved) 1-2 inch diameter steel bulkhead bars extending horizontally from one side of the rigid container to the other side, in parallel with each other. Those bulkhead bars are spaced apart from each other and thus leave openings between them, in the nature of a grating. In certain shipping container apparatus, a reinforced bulkhead sheet of woven material is interposed between the flexitank and the bulkhead bars. Oftentimes, straps or belts are provided to lash the bulkhead sheet tightly against the bars and/or against the flexitank. Plastic ties are also used in certain instances. The bulkhead bars are in close proximity to the inside surfaces of the container doors. Each end of the bulkhead bars fit into the square vertical channel proximate the corresponding door, sometimes referred to as the “lashing channels.” Each channel has 3-5 small elongated lashing bars, spaced along the channel, which are used to lash the reinforced bulkhead sheet. Each of those elongated lashing bars is oriented horizontally, perpendicular to the length of the channel. Each lashing bar has a length extending in the same direction as the length of the rigid container and perpendicular to the container door. Sometimes, a bulkhead blocking structure is positioned on the rigid container floor proximate the container door. That structure includes a series of horizontal and vertical bulkhead bars (1-2 inch in width) welded together into a single unitary frame to which a thick hard plastic sheet is attached, The plastic sheet has an inside or inner surface (facing the flexitank) that shares an imaginary plane with the inside/inner surfaces of the bulkhead bars, and thus serves to form a barrier between the flexitank and the door. The bulkhead structure is kept in position by a series of bolts on either vertical side of the frame. The bolts on one vertical side of the frame extend outward and in a horizontal direction from the side of the frame into the lashing channel of the container). The bolts on the other vertical side of the frame extend into the lashing channel on the opposite side of the inside of the container. However, shipping container apparatus that include these bulkhead bars and blocking structures experience leakage problems.

Accordingly, at least certain embodiments of the present disclosure overcome the leakage problems discussed above, and also provide other benefits, as discussed below.

### SUMMARY

At least one specific embodiment of shipping container system includes a rigid shipping container, a flexitank disposed within the rigid shipping container; and a bulkhead assembly that includes one or more of the features discussed below or elsewhere herein. For example, at least one specific embodiment of a shipping container apparatus comprises a bulkhead assembly comprising two braces and at least one bulkhead panel that is horizontally disposed between the side walls of the container. The bulkhead assembly is interposed between the flexitank and the open end of the rigid shipping container, or the doors (when the doors are in a closed position).

As discussed elsewhere herein, certain specific embodiments of the shipping container systems include only a single bulkhead assembly, which can be (for example) a front-end bulkhead assembly, or an intermediate bulkhead assembly. Other specific embodiments of the shipping container systems include both a front-end bulkhead assembly and an intermediate bulkhead assembly.

Another specific embodiment of shipping container system includes a bulkhead assembly interposed between the flexitank and the open end of the rigid shipping container, that comprises three or more bulkhead panels that include an upper bulkhead panel, one or more intermediate bulkhead panels, and a lower bulkhead panel.

At least one specific embodiment includes a shipping container system, comprising a rigid shipping container, a flexitank disposed within the rigid shipping container, a bulkhead assembly interposed between the flexitank and the open end of the rigid shipping container, and a flexible sleeve comprising a flexible substantially planar composite member, and in at least another embodiment includes two or more sheets of material that are laminated together. Two or more of the sheets may be polymeric, such as polyethylene, polypropylene, and the like. Certain embodiments may comprise one or more layers of felt.

At least one specific embodiment includes a shipping container system, comprising a rigid shipping container having at least a floor, a first side wall with a first side wall inner surface, a second side wall with a second side wall inner surface and an open end; a flexitank disposed within the rigid shipping container, and a bulkhead assembly interposed between the flexitank and the open end of the rigid shipping container. Some embodiments may comprise a cargo net.

At least one specific embodiment includes a shipping container system, comprising a rigid shipping container having at least a floor, a first side wall with a first side wall inner surface, a second side wall with a second side wall inner surface and an open end, a flexitank disposed within the rigid shipping container, a bulkhead assembly interposed between the flexitank and the open end of the rigid shipping container, and three or more gas-filled flexible containers disposed against an upper surface of the flexitank.

Another specific embodiment of a shipping container system comprises a bulkhead assembly that comprises one or more (in some embodiments four, five, or six) generally curved, arc-shaped, or “swept” bars each of which is horizontally disposed between the side walls of the container.

Another aspect of the invention are methods of assembling a rigid bulkhead assembly.

Another aspect of the invention are methods of assembling a curved-bar bulkhead assembly.

Yet another aspect of the invention are methods of assembling a straight-bar bulkhead assembly.

Yet another aspect of the invention is a method of assembling a shipping container system comprising one or more bulkheads (which may include intermediate bulkhead assemblies) selected from the group consisting of rigid bulkhead assemblies, curved-bar bulkhead assemblies, straight-bat bulkhead assemblies, and combinations thereof.

Yet another aspect of the invention are bulkhead bars. In certain embodiments the bulkhead bars are substantially straight (linear); in other embodiments the bulkhead bars have an arcuate-shape, sometimes referred to herein as “swept” shape or “bow” shape or generally curved, similar to a hunting bow used to shoot arrows, having a cord length (length from end to end spanning the arc) substantially equal to a straight bulkhead bar, but having its ends modified (crimped) so that the ends fit into a square lashing channel of a container adjacent the doors of the container. In yet other embodiments, the swept bulkheads bars may comprise a cable connected substantially near each end of the swept bar and spanning the cord length, a construction similar to a bow used for hunting or target shooting. In yet other embodiments, the swept bulkhead bars may have one or more ribs (sometimes referred to herein as power ribs) in the surface of the bar that would face a flexitank in a shipping container system of this disclosure. Certain bulkhead bars may have a combination of these features, for example, swept or arc shape combined with crimped ends and one or more power ribs. Certain other swept bulkhead bars may be simply a generally curved “plain” bar comprised of a hollow steel structure as described herein, which is curved except at both end regions, which are straight so that they fit into lashing channels of a container with having to be crimped at the ends.

These and other features of the systems and methods of the disclosure will become more apparent upon review of the brief description of the drawings, the detailed description, and the claims that follow.

### BRIEF DESCRIPTION OF THE DRAWINGS

The manner in which the objectives of this disclosure and other desirable characteristics can be obtained is explained in the following description and attached drawings in which:

FIGS. 1 and 2 are exploded schematic perspective views of two shipping container systems in accordance with the present disclosure;

FIG. 3A is a perspective view, FIG. 3B is a cross-sectional view, FIG. 3C is a top view, and FIG. 3D is a side elevation view of a vertical brace illustrated in FIG. 1;

FIG. 4 is cross-sectional view of the vertical brace of FIG. 3A-D installed in a vertical wall of a container as illustrated in FIG. 1;

FIG. 5A is a front perspective view, FIG. 5B is a rear perspective view, and FIG. 5C is a cross-sectional view of bulkhead panel as illustrated in FIG. 1;

FIG. 6A is a front perspective view, and FIG. 6B is a side elevation view of a lower bulkhead panel as illustrated in FIGS. 1 and 2;

FIG. 7 is a schematic non-exploded perspective view of the shipping container system illustrated in FIG. 1;

FIG. 8 is a perspective view, with a portion in cross-section, of the sleeve illustrated in FIG. 1;

FIG. 9 is an exploded perspective view of another bulkhead assembly within the disclosure, illustrating another vertical brace embodiment useful with the bulkhead panels illustrated in FIGS. 5 and 6;

FIG. 10A is a more detailed perspective view of the vertical braces illustrated in FIG. 9, and FIGS. 10A and B are cross-sectional views of a vertical brace of FIG. 9 installed in a vertical wall of a container;

FIG. 11 is a perspective view of an intermediate bulkhead assembly embodiment, using the intermediate bulkheads illustrated in FIG. 2;

FIGS. 12A, B, and C are cross-sectional views of one end of the intermediate bulkhead assembly of FIG. 11 installed in a vertical side wall of a container;

FIG. 13 is a more detailed perspective view of one end of the intermediate bulkhead assembly illustrated in FIGS. 11 and 12;

FIG. 14 is a perspective view of a container having the intermediate bulkhead assembly of FIGS. 11-13 installed therein;

FIG. 15 is an exploded perspective view of a generally curved bulkhead bar installed in a container in accordance with one embodiment of the disclosure;

FIG. 16 is a cross-sectional view of one end of the generally curved bulkhead bar of FIG. 15 installed in a vertical side wall of a container;

FIG. 17 is a perspective view of a five generally curved bulkhead bars like those illustrated in FIGS. 15 and 16 installed in a container in accordance with one embodiment of the disclosure;

FIG. 18 is a rear end elevation view of the assembly illustrated in FIG. 17;

FIG. 19 is more detailed perspective view of the generally curved bulkhead bar illustrated in FIG. 15.

FIGS. 20 and 21 are end elevation, partially perspective views of another generally curved bulkhead bar embodiment in accordance with the disclosure having crimped ends;

FIG. 22 is a plan view of one end of the generally curved bulkhead bar illustrated in FIGS. 20 and 21, illustrating more clearly one of the crimped ends of the bar;

FIG. 23 is a perspective view of one of the ends of the generally curved bulkhead bar of FIGS. 20-22 installed in a lashing channel of a container in accordance with the disclosure;

FIGS. 24, 25, and 26 are rear, front, and side elevations, respectively, of one embodiment of a flexible bulkhead panel in accordance with the disclosure;

FIG. 27 is a rear end elevation view of a bulkhead assembly in accordance with disclosure having a flexible bulkhead panel of FIGS. 24-26, four generally curved bulkhead bars of FIG. 28, and one generally curved bulkhead bar of FIGS. 20-22 installed in a container;

FIG. 28 is a perspective view of another embodiment of a generally curved bulkhead bar in accordance with the disclosure;

FIGS. 29A-G and 30A-F are various views of two discharge valves in accordance with the disclosure;

FIGS. 31A-H and 32A-I are various views of three flanges useful with the valves of FIGS. 29 and 30;

FIG. 33A-E are various views of a compression plates useful with the flange illustrated in FIG. 32;

FIGS. 34A and B are side elevation and cross-sectional views, respectively, of another discharge valve useful in shipping container systems of this disclosure;

FIGS. 35, 36, and 37 are perspective views, with portions cut away, of three shipping container systems in accordance with the disclosure;

FIGS. 38 and 39 are perspective views of another generally curved bulkhead bar useful in bulkhead assemblies disclosed herein; and

FIG. 40 is a perspective view of one end of a generally curved bulkhead bar of FIGS. 38 and 39 installed in a lashing channel of a container.

It is to be noted, however, that the appended drawings are not to scale and illustrate only typical embodiments of this disclosure, and are therefore not to be considered limiting of the scope of the claims, for the systems and methods of the disclosure may admit to other equally effective embodiments. Identical reference numerals are used throughout the several views for like or similar elements.

### DETAILED DESCRIPTION

A detailed description will now be provided. The purpose of this detailed description, which includes the drawings, is to satisfy the statutory requirements of 35 U.S.C. §112. For example, the detailed description includes disclosure of the inventors' best mode of practicing the disclosures, a written description of the disclosures, and sufficient information that would enable a person having ordinary skill in the art to make and use the disclosures referenced in the claims.

Each of the appended claims defines a separate disclosure, which for infringement purposes is recognized as including equivalents of the various elements or limitations specified in the claims. Depending on the context, all references below to the “disclosure” may in some cases refer to certain specific embodiments only. In other cases it will be recognized that references to the “disclosure” will refer to subject matter recited in one or more, but not necessarily all, of the claims. Each of the disclosures will now be described in greater detail below, including specific embodiments, versions and examples, but the disclosures are not limited to these embodiments, versions or examples, which are included to enable a person having ordinary skill in the art to make and use the disclosures, when the information in this patent is combined with available information and technology. Various terms as used herein are defined below, and those definitions should be adopted when construing the claims that include those terms, except to the extent a different meaning is given within the specification or in express representations to the Patent and Trademark Office (PTO). To the extent a term used in a claim is not defined below, or in representations to the PTO, it should be given the broadest definition persons in the pertinent art have given that term as reflected in printed publications, dictionaries and issued patents.

Certain claims may include the term “container.” As used herein, the term “container” refers to a rigid container, exemplified by the container 12 depicted in the drawings. The term “container” as used herein (rigid container) is defined as any rigid, metal box-like structure having two opposing vertically disposed side walls that have a length of at least 10 feet and preferably up to 60 feet; a height of at least 6 feet and preferably up to 12 feet; and a width (corresponding generally to the space between the two opposing side walls) of at least 6 feet and preferably up to 12 feet. The container also has a floor that has substantially the same length as the two side walls, and one end wall that is disposed between the side walls at the end of the container, which shall be referred to herein as the “rear wall” (also called the “closed end wall,” or the “closed end” or the “end wall”) of the container. The container also has an end opposite the closed end, which end shall be referred to herein as the “front end” or “open end” of the container. The container has one or more doors, which are flat members positioned at or proximate the open end that are capable of swinging open or closed. At least one embodiment of the container also has a top member, or “lid,” which is used to secure the flexitank inside the container during transportation (shipping). Preferably, the lid is formed of a grating with bars that are formed in crisscross arrangement. Each of the side walls, and the rear wall, has an inside (inner) surface, and an outside (outer) surface. As illustrated in certain drawings herein, each container has an overall inside surface, which is irregular or corrugated (sometimes referred to as having “lazy” corrugations) but is nevertheless considered “substantially planar” as that term is used herein. As discussed in greater detail below, the overall surface of each of the rigid container walls has sub-surfaces (on the inside and outside of the container), which are discussed in greater detail herein and are also themselves referred to as “surfaces.” Also, for clarification, when reference is made herein to any container that has flexible walls, that container will be referred to either as a flexitank or a “flexible container,” or in certain instances that container will be referred to as a “sleeve.”

Any rigid “container” referenced herein is intended to include both a shipping container and truck trailer container. That is, the shipping container and the truck trailer container each qualify as a “container” as defined above. For example, each of them has a structure with the dimensions referenced above. The term shipping container (also called a “cargo container”) is well-known to persons involved in the shipping industry. The shipping container is capable of being used to ship (transport) large quantities of cargo over long distances, typically over water, on ships or barges, or over land on railway cars. A truck trailer container, on the other hand, is a container that also includes a chassis, and wheels, and a structure for attaching chassis to any truck having a diesel engine.

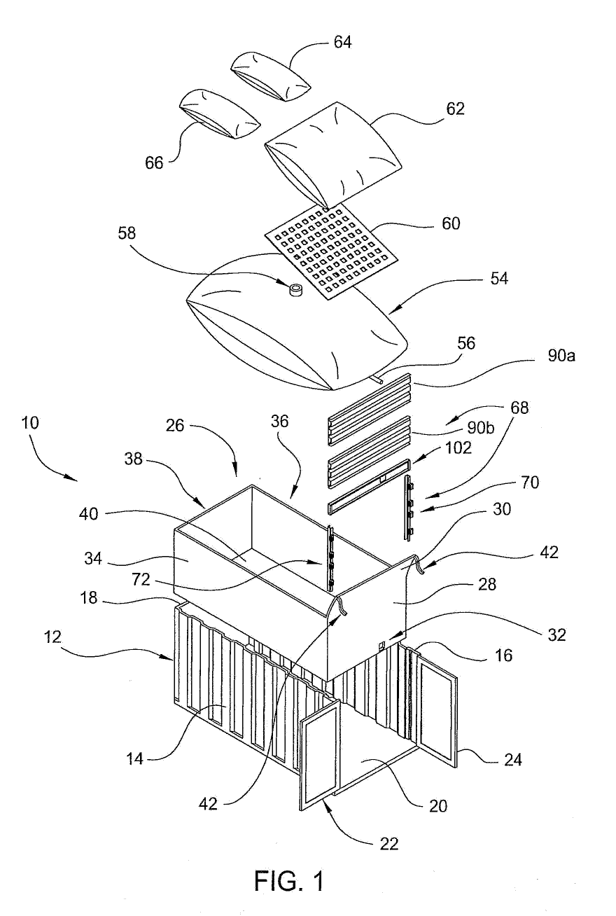

Certain claims herein include a reference to a “flexitank.” As used herein, a “flexitank” is defined as any flexible structure that includes a flexible container having a length and width, inner surface(s), outer surface(s), an interior (inside) capable of holding liquids or flowable solids, and one or more openings through which fluid is capable of passing into or from the inside of the flexitank. There are many different sizes and types (embodiments) of flexitanks, e.g., different categories and/or subcategories of flexitanks. For example, different types of flexitanks may have or include different sizes, shapes, materials and components (e.g., fixtures and/or hardware, including fittings). Thus, unless specified otherwise, or unless apparent from the context, all references herein to a “flexitank” encompass any and all of the many different types of flexitanks. The flexible container component of the flexitank can be, for example, a single-layered bag or a multi-layered bag. The flexible container can also be a combination of bags or layers or liners in which one or more bags or layers or liners are disposed inside of one or more other bags or layers or liners (discussed below). Alternatively, the flexible container can be a laminated bag, comprising different layers laminated together. As discussed herein, the inner surface of the flexitank defines the inside of the flexible container (e.g., an inner cavity). Unless specified otherwise, in an embodiment of the flexitank in which one or more bags are disposed inside of one or more other bags, the “outer surface” of the flexitank refers to the outermost surface of the outermost bag or layer, while the “inner surface” of the flexitank refers to the innermost surface of the innermost bag or layer, which surface is designed for, or capable of, contact with the cargo, e.g., the liquid or flowable solids that are being contained or held by the flexitank. Thus, for example, a multi-layer flexitank may have one or more intermediate layer(s) that is/are sandwiched between 2 other layers, which intermediate layer(s) provide(s) neither an outer flexitank surface nor an inner flexitank surface. The outer surface of the flexitank defines the outside of the flexible container. The flexitank is necessarily capable of holding (containing) any of a variety of flowable materials, such as any liquid (such as wine), or a slurry. In certain embodiments they may transport granular solid particles (e.g., coffee beans or rice), although these products are more typically transported by containers commonly referred to in the art as “dry liners.” A particular flexitank may be in a filled (partially filled, substantially filled, or totally filled) state (condition), for example, if liquid occupies the inside of the flexitank. Alternatively, the flexitank can be in an empty (unfilled) state (condition). As discussed below, the flexitank includes not only the flexible part (e.g., the bags) but also at least one opening. The flexitank that includes separate independent layers preferably also includes at least a fitting corresponding to at least one opening, which fitting can include one or more flanges or any mechanical fitting that clamps the layers together around the opening. The flexitank is preferably “elongated” which, as used herein, means that the flexitank has a length and a width, with sides that define the length (e.g., opposing sides) that are longer than the ends (e.g., opposing ends) which define the width. Preferably, the flexitank is seamless along its length and can be formed from multiple tubes, as discussed in the '982 application, discussed below. When the flexitank is empty and is lying flat on the ground or other horizontal surface (e.g., the inside floor of a rigid shipping container), the flexitank is preferably rectangular. In the rectangular embodiment, the two length-wise sides of the rectangle are parallel to one another; and the two ends of the rectangle are also parallel to one another. When the flexitank is filled (substantially or totally), it has a length and a width, and also has a height. When the flexitank is filled, it preferably has an oblong shape. For example, a flexitank that is substantially or totally filled can be pillow-shaped, as illustrated in certain drawings herein. The flexitank has an overall size, including all its dimensions, such that it is capable of fitting into a rigid shipping container, both in an empty state and in a filled state. For example, a flexitank can have a length of from 5, or 15, or 20 feet, to 30, or 50, or 60 feet. That flexitank can have a width of from 3, or 4, or 5 feet to 6, or 8, or 12 feet. The flexitank can have a height (when filled) of from 1, or 2, or 3 feet to 4, or 7, or 10 feet. The flexitanks have dimensions (length, width and height such that, in both an empty and filled condition, they can fit inside of whatever rigid container they are used with. They can have a volumetric capacity ranging anywhere from 5,000 liters to 30,000 liters. The flexitank can have a plurality of different components, including the bags or sheets of which the flexible container is made. For example, as noted above, certain flexitanks include a combination of bags (sometimes also referred to as “bladders”), in which bags are disposed within other bags. Certain examples of a flexitank are disclosed in the True application, mentioned above, U.S. Ser. No. 11/124,982, Publication No. US 2006/0251343 (“982 application”). All the parts of that application referring to “flexible multi-layer containers,” and the manner of making them, are hereby incorporated by reference, including the flanges and fittings, are also incorporated by reference. Specifically, the parts of Publication No. US 2006/0251343 that are incorporated herein by reference are FIGS. 1-20 and paragraphs [0031]-[0060].

A flexitank may include strength-reinforcing weaves (sometimes referred to as strength bands in the art) in its outermost layer. Flexitanks may have anywhere from 1 to 2, or from 1 to 4, or from 1 to 6, or even more layers. Two typical embodiments are 2-layer materials, one embodiment comprised of 2 14-mil layers of polyethylene, and the second comprised of one 14-mil ply or layer of EVOH (ethylene vinyl acetate) and one 14-mil layer of polyethylene. Other materials which may be employed include, but are not limited to those wherein one layer is selected from polymers including amorphous poly(ethylene terephthalate) (APET), polypropylene (PP), high-density poly (ethylene) (HDPE), poly(vinylchloride) (PVC), poly(styrene) PS, and mixtures, copolymers, combinations and layered versions thereof, wherein each layer may be a mixture or copolymer of two or more of these. The second layer may be a mono layer, a homopolymer or blends of polymers, or a coextruded film comprised of distinct multiple layers with homopolymer or blends of polymers within each layer. Polymers that may be used in the second layer may be selected from ethylene-vinyl acetate (EVOH), poly(ethyl)methacrylate (EMA), high-melt strength LDPEs, and metallocenes such as metallocene poly(ethylenes), also known as plastomer metallocene poly(ethylenes), low-density poly(ethylene) (LDPE), ultra-low density linear poly(ethylene) (ULLDPE), linear low density poly(ethylene) (LLDPE), K-resin, PP, poly(butadiene), and mixtures, copolymers, and layered versions of two or more of these, wherein each layer may be a mixture, copolymer, or some other combination of these polymers. As used herein the term “copolymer” includes not only those polymers having two different monomers reacted to form the polymer, but two or more monomers reacted to form the polymer.

The flexible material may meet the standards as detailed in Table 1.

TABLE 1

| | | |
|---|---|---|
| Tensile Strength | ASTM D-882 | PE 68 ppi |
| | | EVOH 35 ppi |
| Peak Elongation MD | ASTM D-882 | PE 1000% |
| | | EVOH 655% |
| Puncture Resistance (lbs) | ASTM D-3420 | PE 4000 (dart) |
| | | EVOH 1500 (dart) |
| Oxygen Permeation | ASTM D-3985 | PE 20 cc/100 in2/day Max. |
| | | EVOH 0.027 cc/100 |
| | | in2/day Max |
| Moisture Transfer (perms) | ASTM F-1249 | PE 0.03 |
| | | EVOH 0.05 |
| Effective Temperature | | 167° F. to −23° F. or |
| Range | | 75° C. to −5° C. |

An empirical measurement widely used to characterize controlled-atmosphere packaging materials is the oxygen transport (or oxygen transmission or oxygen permeation) rate. The oxygen transmission rate (OTR) of any given material is expressed as cc O₂/m²-day-atmosphere. Several related units of measure are also widely used in the field, such as cc O²/100 in²/mil thickness of film/24 hours. Another widely employed means of measuring OTR is described in ASTM D3985-81, which yields an OTR measurement having the units of cc O₂/100 in²/24 hours. (In ASTM D3985-81, the thickness of the film tested in not included in the units expressing the OTR.) The CO₂ transmission rate is also an important physical measurement in certain packaging films. The ratio between the CO₂ transmission rate and the OTR is designated the “beta value.”

As used herein, the phrase “gas-permeability” refers to the transport of gases such as oxygen, nitrogen and carbon dioxide across a membrane. Unless otherwise noted, “gas-permeability” refers to all gases in general.

“Oxygen transport (or transmission) rate (OTR)” as used herein designates oxygen transport rate as measured by ASTM D3985-81 or any equivalent protocol. See also ASTM F1307-02.

The flexitank may further include a first seam and a second seam. The seams would be placed parallel to the front and rear ends of a container when placed inside the container.

The flexitank may also have one or more openings (apertures) in the flexible material itself by which air or cargo (liquid or granular) can be introduced to, or discharged from, the inside of the flexitank. Examples of such openings include an input opening, a discharge opening and/or a vent opening. Other components are structures associated with each of the openings such as, for example: a discharge valve with a handle that is capable of being rotated from a closed position to an open position; a fitting for the discharge valve that may include one or more flanges; a vent line associated with a vent opening for releasing air from the inside of the flexitank; and a fitting for the vent line that may include one or more flanges. Examples of fittings are disclosed in the '982 application referenced above. Any flexitank referenced herein preferably includes at least one independent inner layer (e.g., an inner bag or liner) that is disposed inside another independent layer (e.g., an intermediate bag or liner), which is disposed inside yet another independent layer (e.g., an outer bag or liner). Those three layers can be regarded as three independent bags (e.g., bladders) combined to form a single composite bag. Examples of a flexitank that includes a combination of three bags, layers or liners are disclosed in the '982 application referenced above.

Various specific embodiments disclosed herein include at least one novel type of bulkhead assembly. As used herein, the term “bulkhead assembly” itself broadly means any structure disposed between a filled flexitank that is located inside the rigid container and the inside surface of either or both of the container doors, when they are closed, or the front end of the container when the container doors are open. There are various types of bulkhead assemblies. Certain bulkhead assemblies that have been used in the past include the blocking structures discussed in the background section, above, which include a rectangular structure placed on the floor of the container between the flexitank and the inside of the container door(s), which structure includes an opening through which a discharge valve member can protrude, and which structure includes bolts that fit into the rigid container lashing channels. Another type of bulkhead assembly includes the reinforcing cross-bars discussed in the background, which are positioned horizontally and/or vertically to separate the filled flexitank from the inner surface of the door(s), and to thus restrain the flexitank. Bulkhead assemblies can also include a flexible sheet, e.g., a tarp that is tied to the cross-bars and/or to struts that are an integral part of the container. Although those types of bulkhead assemblies, which have been used in the past, can be used as part of certain embodiments discussed below, the preferred embodiments of shipping container apparatus include novel bulkhead assemblies, as disclosed in greater detail below.

At least one specific embodiment of a shipping container apparatus disclosed herein includes a sleeve. As used herein, the term “sleeve” is itself broadly defined to mean any flexible structure that can be placed inside a rigid container to provide a barrier between the outer surface of the flexitank and inner walls of the container, and has at least a floor with two opposing side walls (panels) and a rear wall (panel). In one or more specific embodiments, the sleeve is a flexible abrasion vapor containment structure. Such a structure is flexible and also serves to protect the flexitank from experiencing abrasion, which has the potential for leakage. Such a structure also prevents vapor from passing through the layer(s) of the sleeve by virtue of including a layer that is vapor-impermeable. The sleeve fits into a rigid container, and is sized accordingly. The sleeve is preferably open at the top, so that the top surface of the flexitank can be viewed during shipment. The term “sleeve” is itself not restricted to any particular shape, size, or material. As discussed below, at least one version of the sleeve is box-like in shape, and has a horizontally disposed floor and four vertical walls (panels) configured to fit on the inside of a rigid container (e.g., a shipping container). The boxlike version has creases along the four lower edges of the side walls (panels) where those side walls (panels) adjoin the flexible rectangular floor. As an alternative to the box-like version, at least one version of the wear-sleeve is rounded at the places where the floor of the sleeve adjoins the side walls (panels), such that, unlike the aforementioned box-like version, there is no crease between the floor and each side wall (panel) of the sleeve that separates the flexitank from the inside walls of the rigid container. The rounded version of the sleeve is thus more tube-like than box-like in shape. At least one version (embodiment) of the sleeve has a floor panel that, when placed into a rigid shipping container, is disposed horizontally on the container floor, and also has at least three flexible sleeve walls that, when the sleeve is placed into a rigid shipping container, are substantially vertically oriented so that the sleeve provides a barrier between the outer surface of the flexitank and inner walls of the container. Preferably, the sleeve has at least four flexible walls (panels) that are vertically oriented, and all vertical walls (panels) are integrally attached along one edge to the sleeve floor. Other versions of the sleeve, and various aspects or features of those versions, are described below.

A “shipping container system” may comprise a container, one or more flexitanks, one or more bulkhead assemblies which may be the same or different, one or more sleeves, and any other component mentioned herein.

Other terms that are used in this specification, and/or terms used in the claims, are defined below in the context of specific embodiments.

### Specific Embodiments

At least one specific embodiment of shipping container system includes a rigid shipping container, a flexitank disposed within the rigid shipping container; and a bulkhead assembly that includes one or more of the novel features discussed below or elsewhere herein. For example, at least one specific embodiment of a shipping container system comprises a rigid shipping container having at least a floor, a first side wall with a first side wall inner surface, a second side wall with a second side wall inner surface, a rear wall having a rear wall inner surface and an open end; a flexitank disposed within the rigid shipping container, in the space between the two side walls; and a bulkhead assembly comprising two braces and at least one bulkhead panel that is horizontally disposed between the side walls of the container. The bulkhead assembly is interposed between the flexitank and the open end of the rigid shipping container, or the doors (when the doors are in a closed position).

As discussed elsewhere herein, certain specific embodiments of the shipping container system include only a single bulkhead assembly, which can be (for example) a front-end bulkhead assembly, or an intermediate bulkhead assembly. Other specific embodiments of the shipping container system include both a front-end bulkhead assembly and an intermediate bulkhead assembly.

A front-end bulkhead assembly can be any bulkhead assembly positioned proximate the container doors that include a structural member (e.g., a bolt or support box or support wedge) disposed within the lashing channel. In certain embodiments, the front-end bulkhead assembly includes at least one horizontal bulkhead panel and at least two braces, as defined elsewhere herein, which may be braces that include vertical channels for receiving an outer edge of the bulkhead panel. Other specific embodiments of the front-end bulkhead assembly are discussed below, and elsewhere herein, including the drawings.

The single bulkhead assembly can also be an intermediate bulkhead assembly that is positioned on the inside of the rigid container at an intermediate point (location) in the rigid container. As noted above, any bulkhead assembly referenced herein includes at least one bulkhead panel disposed horizontally between the two side walls of the rigid container. The intermediate bulkhead assembly is disposed between two “intermediate” points (locations) on the opposing side walls of the rigid container. The term “intermediate” in that context means any location along the rigid container side walls that is from 30% to 70% of the total distance from the rear wall of the rigid container to the front end. In certain embodiments an intermediate point is a midway point between the rear wall of the container and the front end, which would be 50% of the total distance.

One or more specific embodiments of the shipping container systems of this disclosure include a rigid container, a flexitank and a bulkhead assembly that includes at least two “retainers,” at least two “braces,” and at least one bulkhead panel extending between the two braces. As discussed below, in certain embodiments the retainers may be each disposed vertically along (and more preferably in direct contact with) an inner surface (or one or more inner sub-surfaces) of the rigid container. Similarly, the braces may each be disposed vertically along (and more preferably in direct contact with) an inner surface (or one or more inner sub-surfaces) of the rigid container. In certain embodiments, each retainer is disposed in direct contact (i.e., physical contact) with an inner surface of the rigid container; each brace is disposed in direct contact with the retainer; and each of the one or more bulkhead panels is disposed between the two braces, in which case the brace secures and supports the bulkhead panels against undue back-and-forth movement and the retainer secures and supports the braces against the inside walls of the rigid container, and prevent or inhibit undue back-and-forth movement of the braces and bulkhead panels.

In certain specific embodiments, the two braces include a first brace disposed vertically along a portion of the first side wall inner surface; a second brace disposed vertically along a portion of the second side wall inner surface; and a bulkhead panel member extending horizontally between the first brace and the second brace. The first and second braces that are disposed vertically along the side wall inner surfaces can be, in at least one specific embodiment, disposed directly against the side wall inner surfaces, by being in direct contact with those side wall inner surfaces. Alternatively, in at least one specific embodiment, the first and second braces that are disposed vertically along the side wall inner surfaces can be disposed indirectly against the side wall inner surfaces, by making direct contact with a “retainer,” also referred to herein as an intervening structure interposed between the brace and the inner container wall. Alternatively, in at least one specific embodiment, a shipping container system includes both a first bulkhead assembly that has first and second braces that are disposed vertically along the side wall inner surfaces, and are in direct contact with those side wall inner surfaces; and a second bulkhead assembly that has first and second braces that are disposed vertically along the side wall inner surfaces, and are in direct contact with first and second retainers that are disposed vertically along the side wall inner surfaces, and in the space between the first and second braces and the side wall inner surfaces.

In at least one specific embodiment, the vertical brace referenced above, and elsewhere herein, can comprise (include) a vertical channel, which includes at least a structure having at least two elongated planar side members with opposing surfaces that are preferably in parallel planes or in substantially parallel planes (i.e., 30 degrees or less with one another); and at least one elongated intermediate planar member disposed between the two elongated planar side members, which intermediate member couples (and preferably connects) the two side members, and forms an elongated opening that is sized to receive at least part of a bulkhead panel (e.g., the end portion of the bulkhead panel). For example, in certain embodiments the closest distance separating the two elongated planar side members is at least 2 inches and in other embodiments is from 3-5 inches. In certain embodiments, the vertical channel is “totally continuous,” in that there are no intervening structures within the channel that prevent a bulkhead panel disposed between two opposing vertical channels (that are part of the braces) from sliding down the entire length of the vertical channel, from one end of the vertical channel (e.g., the top end) to another end of the vertical channel (e.g., the bottom end) as part of a bulkhead assembly installation. Similarly, during disassembly, when the bulkhead panel is being removed, the vertical channel is “totally continuous” so that each panel can be slid upward within the channel from the bottom end to the top end. In an embodiment where some intervening structure is located within the channel (e.g., a bolt that may be temporarily placed in the channel), the channel is “substantially continuous,” so that a bulkhead panel can be at least slid downward from a upper portion of the channel to a lower portion of the channel, and vice versa, i.e., slid upward from a lower portion of the channel to an upper portion of the channel. For example, any of the beams illustrated in the drawings as being examples of braces have vertical channels, which are preferably sized and positioned to receive an end of any of the horizontal bulkhead panels described herein.

In at least one specific embodiment, the shipping container system identified above, or elsewhere herein, comprises a first brace that is removably disposed along a portion of the first side wall inner surface, and that first brace can be removably disposed directly against the first side wall inner surface, i.e., in direct contact with that surface, or the first brace can be removably disposed directly against a first retainer, i.e., in direct contact with the first retainer, and the first retainer is in direct contact with the first side wall inner surface.

In at least one specific embodiment, the shipping container system identified above, or elsewhere herein, comprises a first brace that includes an elongated member having an upper end and a lower end. In at least one specific embodiment, the lower end is in contact with the floor of the rigid container, and the upper end corresponds to a point between halfway the height of the rigid container walls and the height of the rigid container walls. In a specific embodiment, the distance between the upper end of the first brace (when disposed against the inner side wall of the container) and the top of the rigid container wall is greater than the height of each of the bulkhead panels, but less than twice the height of each of the bulkhead panels.

In at least one specific embodiment, the shipping container system identified above, or elsewhere herein, comprises a bulkhead panel member that includes an end portion and a first brace that includes a vertical channel that is capable of receiving the end portion of the bulkhead panel.

In at least one specific embodiment, the shipping container system identified above, or elsewhere herein, comprises (includes) a vertical brace that includes an elongated member having two facing elongated sub-members, sides or surfaces, with an intermediate elongated sub-member, side or surface between the two facing elongated sub-members, sides or surfaces, which intermediate elongated sub-member, side or surface can be planar and strictly perpendicular, or can be arc-shaped or curved, or can include two surfaces or portions that form an angle of less than 45 degrees or less than 30 degrees to one another. For example, the vertical brace can include a first elongated side member (sub-member), a second elongated side member (sub-member), and a third elongated side member (sub-member), wherein: the first elongated side member (sub-member) is substantially perpendicular to the second elongated side member (sub-member) and forms a first corner edge; the third elongated side member (sub-member) is substantially perpendicular to the second elongated side member (sub-member) and forms a second corner edge; and the second elongated side member (sub-member) is disposed against an inner surface of the container when the bulkhead panel member (sub-member) is disposed between the first vertical brace and the second vertical brace.

In at least one specific embodiment, the shipping container system identified above, or elsewhere herein, comprises: a first brace that includes a first elongated member having a first upper end and a first lower end, and a first elongated channel extending between the first upper end and the first lower end, wherein the first elongated channel includes a first inner primary brace surface; a second brace that includes a second elongated member having a second upper end and a second lower end, and a second elongated channel extending between the second upper end and the second lower end, wherein the second elongated channel includes a second inner primary brace surface; and the bulkhead panel member extends horizontally between the first brace and the second brace and includes an elongated inner surface facing the rear wall of the rigid container, an elongated outer surface facing the doors or open end of the rigid container, a first end and a second end, wherein the first end of the bulkhead panel member is capable of fitting into the first elongated channel and making contact with the first inner primary brace surface and the second end of the reinforcing member is capable of fitting into the second elongated channel and making contact with the second inner primary brace surface.

In at least one specific embodiment, the shipping container system identified above, or elsewhere herein, comprises a first brace that includes a first elongated member that has a first receiving portion and is capable of being disposed vertically against (directly or indirectly) a first inner surface of a shipping container; and a second brace that includes a second elongated member that has a second receiving portion and is capable of being disposed vertically against a second inner surface of a shipping container; and a bulkhead panel that includes a first end and a second end, wherein the bulkhead panel has a first end capable of fitting into the first receiving portion and a second end capable of fitting into the second receiving portion at the same time the first end fits into the first receiving portion.

In at least one specific embodiment, the shipping container system identified above, or elsewhere herein, comprises at least two vertical braces each of which includes a channel with perpendicular sides, the first brace comprises an elongated member and one or more secondary members, the elongated member having a first elongated side, a second elongated side, and a third elongated side, wherein the second elongated side of the elongated member is disposed against an inner surface of the container and at least one of the secondary members has at least a first side, a second side, and a third side, wherein the first side is substantially perpendicular to the second side and forms a first corner edge; the third side is substantially perpendicular to the second side and forms a second corner edge; and the first side of the secondary member is juxtaposed against the third elongated side of the elongated member and at least a portion of at least one of the secondary members is disposed within the bulkhead channel.

In at least one specific embodiment, the shipping container system identified above, or elsewhere herein, comprises a bulkhead panel extending between the first brace and the second brace and has an inner surface and an outer surface, and a flexitank disposed within the rigid shipping container is filled such that pressure is applied by the flexitank against the first side wall inner surface, and also against the second side wall inner surface and also against the inner surface of the reinforcing member.

In at least one specific embodiment, the shipping container system identified above, or elsewhere herein, comprises the first elongated channel extending continuously from the upper end to the lower end, or wherein the second elongated channel extends continuously from the upper end to the lower end.

In at least one specific embodiment, the shipping container system identified above, or elsewhere herein, comprises a first elongated channel extending discontinuously from the upper end to the lower end, or wherein the second elongated channel extends discontinuously from the upper end to the lower end.

In at least one specific embodiment, the shipping container system identified above, or elsewhere herein, comprises a first elongated channel extends from a location proximate the upper end to a location proximate the lower end, or wherein the second elongated channel extends from a location proximate the upper end to a location proximate the lower end.

At least one specific embodiment includes a shipping container system, comprising a rigid shipping container having at least a floor, a first side wall with a first side wall inner surface, a second side wall with a second side wall inner surface, a rear wall with a rear wall inner surface and an open end; a flexitank disposed within the rigid shipping container; and a bulkhead assembly interposed between the flexitank and the open end of the rigid shipping container, comprising three or more bulkhead panels that include an upper bulkhead panel, one or more intermediate bulkhead panels, and a lower bulkhead panel.

At least one specific embodiment includes a shipping container system, comprising a rigid shipping container having at least a floor, a first side wall with a first side wall inner surface, a second side wall with a second side wall inner surface and an open end; a flexitank disposed within the rigid shipping container; and a bulkhead assembly interposed between the flexitank and the open end of the rigid shipping container, comprising two vertical braces and three or more bulkhead panels disposed between the vertical braces that include an upper bulkhead panel, one or more intermediate bulkhead panels, and a lower bulkhead panel.

At least one specific embodiment includes a shipping container system comprising a rigid shipping container having at least a floor, a first side wall with a first side wall inner surface, a second side wall with a second side wall inner surface and an open end; a flexitank disposed within the rigid shipping container; and a bulkhead assembly, comprising three bulkhead panels, each bulkhead panel having a horizontal width, a vertical height that is greater than the horizontal width, and a horizontal length that is greater than the vertical height.

In at least one specific embodiment, any of the shipping container system identified above, or elsewhere herein, comprises an upper bulkhead panel that is disposed above the one or more intermediate bulkhead panels; one or more intermediate bulkhead panels that are disposed above the lower bulkhead panel, wherein each of the three bulkhead panels preferably has an upper edge portion and a lower edge portion; wherein the upper edge portion of the lower bulkhead panel is preferably disposed in supportive relation with respect to the lower edge portion of one of the intermediate bulkhead panels; and wherein the upper edge portion of one of the intermediate bulkhead panels is preferably disposed in supportive relation with respect to the lower edge portion of the upper bulkhead panel.

In at least one specific embodiment, the shipping container system identified above, or elsewhere herein, comprises bulkhead panels that include horizontal sides and vertical sides, in which the length of each of the horizontal sides is greater than the length of each of the vertical sides, and the horizontal sides are coplanar with one another; and extend from the first side wall to the second side wall.

At least one specific embodiment includes a shipping container system comprising a rigid shipping container, a flexitank disposed within the rigid shipping container, a bulkhead assembly interposed between the flexitank and the open end of the rigid shipping container; and a flexible sleeve. For example, a shipping container apparatus is provided that includes a rigid shipping container having at least a floor, a first side wall with a first side wall inner surface, a second side wall with a second side wall inner surface and an open end; a flexitank disposed within the rigid shipping container, wherein the flexitank has a first flexitank outer surface proximate the first side wall inner surface of the rigid shipping container and a second flexitank outer surface proximate the second side wall inner surface of the rigid shipping container; a bulkhead assembly interposed between the flexitank and the open end of the rigid shipping container; and any flexible sleeve as disclosed herein, preferably a flexible sleeve having at least four members, e.g., walls (panels) that are preferably integrated as part of single sleeve, e.g., joined together by laminating or fusing or stitching or otherwise. The first member (e.g., a vertical panel) is flexible and substantially planar and is interposed between the first side wall inner surface of the rigid shipping container and the first flexitank outer surface. The second member (e.g., a vertical panel) is also flexible and substantially planar and is interposed between the second side wall inner surface of the rigid shipping container and the second flexitank outer surface. Preferably, the vertical panels are joined by a floor panel, and the sleeve preferably also includes a rear panel and a front panel. Preferably, the front panel includes a flap (as disclosed in the drawings) and optionally also has a cargo net integrated therein, e.g., stitched or formed as an integral part of a unitary sleeve.

At least one specific embodiment includes a shipping container system comprising a rigid shipping container having at least a floor, a first side wall with a first side wall inner surface, a second side wall with a second side wall inner surface and an open end; a flexitank disposed within the rigid shipping container; a bulkhead assembly interposed between the flexitank and the open end of the rigid shipping container; and a flexible sleeve comprising a flexible substantially planar composite member that in at least one embodiment comprises at least one layer of felt and in a least another embodiment includes three or more sheets that are laminated together, any of which can include felt as disclosed elsewhere herein.

At least one specific embodiment includes a shipping container system comprising a rigid shipping container having at least a floor, a first side wall with a first side wall inner surface, a second side wall with a second side wall inner surface and an open end; a flexitank disposed within the rigid shipping container; a bulkhead assembly interposed between the flexitank and the open end of the rigid shipping container; and a flexible sleeve.

In at least one specific embodiment, the shipping container system identified above, or elsewhere herein, comprises a rigid container having: (i) a container floor that includes a substantially planar rectangular member with a substantially planar and substantially rectangular inner surface; (ii) a first container side wall that includes a substantially planar rectangular member with a corrugated inner surface (e.g., that includes multiple sub-surfaces each having at least three different planar orientations); (iii) a second container side wall that includes a substantially planar rectangular member with a corrugated inner surface (e.g., that includes multiple sub-surfaces each having at least three different planar orientations); and (iv) a container back-end wall that includes a substantially planar rectangular member with a corrugated inner surface (e.g., that includes multiple sub-surfaces each having at least three different planar orientations), wherein the inner surfaces of the floor, first and second side walls and end wall are disposed together to define an interior of the rigid container having an inside container surface.

In at least one specific embodiment, the shipping container system identified above, or elsewhere herein, comprises a flexible sleeve that includes a laminated composite sheet composed of at least three individual sheets laminated together, which sleeve is removably disposed inside the rigid metallic container, which sleeve is disposed against the inside container surface, and which sleeve includes: (i) a flexible sleeve floor (floor panel) that includes a substantially planar and substantially rectangular member which is disposed substantially against the inner surface of the container floor; (ii) a flexible first sleeve side wall (panel) which includes a substantially planar and substantially rectangular member which is disposed substantially against the inner surface of the first container side wall (panel); (iii) a flexible second sleeve side wall (panel) which includes a substantially planar and substantially rectangular member which is disposed substantially against the inner surface of the second container side wall (panel); and (iv) a flexible sleeve end wall (panel) which includes a substantially planar and substantially rectangular member which is disposed substantially against the inner surface of the container back-end wall (rear panel).

In at least one specific embodiment, the shipping container system identified above, or elsewhere herein, comprises a rigid container that additionally includes a door-end that includes a substantially rectangular opening and at least one door capable of an open or closed position; and the flexible sleeve additionally includes a flexible sleeve door-end wall which includes a substantially planar and substantially rectangular member.

In at least one specific embodiment, the shipping container system identified above, or elsewhere herein, comprises a flexible sleeve door-end wall of the flexible sleeve includes an opening through which a flexitank valve member is capable of fitting, such that one portion of the valve member is connected to the flexitank to receive fluid or flowable cargo and another portion of the valve member has a valve handle that is capable of an open or closed position.

In at least one specific embodiment, any shipping container system identified above, or elsewhere herein, comprises at least three individual sheets laminated together include at least one sheet that comprises plastic.

In at least one specific embodiment, any shipping container system identified above, or elsewhere herein, comprises at least three individual sheets laminated together include at least one sheet that comprises a material capable of absorbing liquid.

In at least one specific embodiment, any shipping container system identified above, or elsewhere herein, the material capable of absorbing liquid comprises felt.

In at least one specific embodiment, any shipping container system identified above, or elsewhere herein, comprises at least three individual sheets laminated together includes at least one sheet that includes an outer coating comprising a metal.

In at least one specific embodiment, any shipping container system identified above, or elsewhere herein, that comprises a sleeve with an outer coating comprising metal, the metal may comprise aluminum.

In at least one specific embodiment, any shipping container system identified above, or elsewhere herein, comprises at least three individual sheets laminated together may include at least an inner sheet that comprises felt, an outer sheet that comprises an aluminum coating and an intermediate sheet that comprises polyethylene.

In at least one specific embodiment, any shipping container system identified above, or elsewhere herein, comprises a flexitank disposed inside a flexible sleeve.

In at least one specific embodiment, any shipping container system identified above, or elsewhere herein, that comprises a flexitank disposed inside a flexible sleeve, the sleeve has a first opening that includes an air valve for releasing air from inside the flexitank and a second opening that includes a product discharge valve for releasing product from inside the flexitank.

At least one specific embodiment of a shipping container system comprises a rigid shipping container having at least a floor, a first side wall with a first side wall inner surface, a second side wall with a second side wall inner surface and an open end; a flexitank disposed within the rigid shipping container; a bulkhead assembly interposed between the flexitank and the open end of the rigid shipping container; and a cargo net.

At least one specific embodiment of a shipping container system comprises a rigid shipping container having at least a floor, a first side wall with a first side wall inner surface, a second side wall with a second side wall inner surface and an open end; a flexitank disposed within the rigid shipping container; a bulkhead assembly interposed between the flexitank and the open end of the rigid shipping container; and three or more gas-filled flexible containers disposed against an upper surface of the flexitank.

As discussed above, and elsewhere herein, one or more specific embodiments of the shipping container systems may include one or more “retainers.” As used herein, the term “retainer” means any elongated structure (other than a brace) that is disposed vertically along and preferably against and in direct contact with an inside surface of the rigid container, and is preferably disposed between a brace and an inside surface of the rigid container. In certain embodiments each retainer includes at least three elongated members, e.g., two elongated side members and an elongated intermediate member disposed between the two elongated side members, and preferably the elongated intermediate member has a first edge that it shares with an edge of one of the elongated side members and a second edge that it shares with an edge of the other elongated side member. In certain embodiments, the retainer has at least three outer surfaces that correspond to and are in direct (physical) contact with at least three sub-surfaces of the inside of the rigid container, and more preferably nests within one of the indentations existing on the inside surface of the container, defined by the lazy corrugations of that rigid container inside surface. In certain embodiments the retainer includes at least one horizontal structural member that has an aperture for receiving an elongated structure (e.g., a pin, or cylindrical member or bolt) that holds and secures a brace that is disposed against (preferably in physical contact with) the retainer.

In one or more specific embodiment, a retainer is disposed vertically along (and more preferably in direct contact with) an inner surface (or one or more inner sub-surfaces) of the rigid container. In certain embodiments a brace is disposed vertically along (and more preferably in direct contact with) an inner surface (or one or more inner sub-surfaces) of the retainer. In certain embodiments each of the one or more bulkhead panels is disposed between the two braces, in which case the brace secures and supports the bulkhead panels against undue back-and-forth movement and the retainer secures and supports the braces against the inside walls of the rigid container, and prevents or inhibits undue back-and-forth movement of the braces and bulkhead panels.

As noted above, and elsewhere herein, at least one embodiment of a vertical brace, e.g., a vertical brace that is part of a front-end bulkhead assembly, is disposed removably and vertically and directly against (in direct contact with) an inner surface of the rigid container. At least one embodiment of a vertical brace includes a primary brace member that is elongated and preferably includes an elongated vertical channel that is capable of receiving an end portion of a bulkhead panel, and a secondary brace member that is affixed to the primary brace member (preferably permanently affixed, e.g., by welding, and on one side of the primary brace member). In certain specific embodiments, the secondary brace member is a box-shaped support member, sized to fit into the square lashing channel of the rigid container. In other specific embodiments, the secondary brace member is (or includes) a cam, in certain embodiments a triangular or wedge-shaped cam, which has at least one curved surface. In one of more specific embodiment, the secondary brace member is removably disposed against any one of the inside surfaces of the lashing channel of the rigid container. In certain embodiments, that secondary brace member is removably disposed against the inside surface of the lashing channel that is closest to the front end of the container and the doors. In one or more specific embodiments, e.g., an embodiment in which the bulkhead assembly includes a retainer, the secondary brace member is removably affixed to the retainer, and is rotatably affixed, e.g., by a pin.

Accordingly, in a specific embodiment of the shipping container system that includes a rigid shipping container, a flexitank positioned on the inside of the rigid shipping container, and an intermediate bulkhead assembly that includes two vertically disposed retainers, two vertically disposed braces and bulkhead panels are disposed horizontally between the two vertically disposed braces, wherein the bulkhead panel ends are inserted within the vertical channels of the braces, it is contemplated that any substantial lateral movement of the flexitank away from the rear wall and toward the front end (e.g., during actual use) will cause the flexitank to press against the inside surface of the bulkhead panel, which transfers forces against the bulkhead panel in the direction of the doors, which in turn causes the bulkhead panel to move forward in the direction of the doors. In a specific embodiment, this movement of the bulkhead panel causes the secondary brace member to rotate with respect to (e.g., around) the pin, which is any elongated structure that permits such rotation. The rotation causes the brace to move forward until it reaches a stopping point, which is preferably when the surface of at least one portion of the secondary brace member makes contact with a surface of the retainer such that rotation of the secondary brace member is halted.

In a specific embodiment of the shipping container system that includes a rigid shipping container, a flexitank positioned on the inside of the rigid shipping container, and a forward bulkhead assembly that includes two vertically disposed braces and bulkhead panels are disposed horizontally between the two vertically disposed braces, wherein the bulkhead panel ends are inserted within the vertical channels of the braces, it is likewise contemplated that any substantial lateral movement of the flexitank away from the rear wall and toward the front end (e.g., during actual use) will cause the flexitank to press against the inside surface of the bulkhead panel, which transfers forces against the bulkhead panel in the direction of the doors. In at least one specific embodiment, this transfer of force causes the bulkhead panel to move forward in the direction of the doors, and in at least certain specific embodiments, that movement of the bulkhead panel causes the secondary brace member to move forward until it reaches a stopping point, which is preferably when the surface of at least one portion of the secondary brace member makes contact with a surface of the lashing channel retainer such that movement of the secondary brace member, and the bulkhead panel, is halted.

Another specific embodiment of a shipping container system comprises a bulkhead assembly comprising one or more (in some embodiments two, three, four, five, six, seven, or even ten or twenty curved, arc-shaped, or “swept” bulkhead bars as described herein, each of which is substantially horizontally disposed between the side walls of a container. The cross-sections of these curved bulkhead bars may be of the “B” type, as is known for bars typically used in automotive bumper applications, in which a single piece or sheet of thin steel is rolled into a folded-over configuration so that its cross-section resembles a “B”. Certain bars may have a cross-section where the two lobes of the B have ribs or indentures, which have proven to have greater strength properties than the standard B shape bars. Specific embodiments of the swept bars are illustrated and their features explained further herein. Each swept bar has opposing ends capable of fitting, removably, into corresponding lashing channels (with or without vertical braces). Also as illustrated schematically in certain drawings herein, the curved bulkhead bars may also comprise a steel or other cable extending lengthwise substantially from one end of the bar to the other end, similar to the string on a bow used to shoot arrows. Unlike other bulkhead bars disclosed herein and previously in the art, a bulkhead assembly that includes one or more of the curve, swept bulkhead bars do not require a vertical brace, saving weight and space in shipping container system using them. The swept bars may be held in place in a bulkhead assembly so that they do not slip down or move up the lashing channels. Support straps connected to the outside surface of one or more flexible bulkhead panels may include hook and loop fasteners (such as available under the trade designation VELCRO®, from Velcro USA Inc., Manchester, N.H., USA), or other fasteners such as snaps, belts with buckles, latches, and the like, so that the straps may be used to affix the bars to the flexible bulkhead panel(s).

During use of shipping container systems having curved bulkhead bars, the curved or bow shape of the bars serve as massive shock absorbers or springs, so that a loaded or semi-loaded flexitank (which may contain a substantial volume of fluid, or granular solid products, or combination thereof) can apply a substantial force against the bars, and the bars will tend to resist bending so that they tend to want to straighten or lengthen, but the natural curvature of the bars pushes the flexitank back toward the inside of the container. The bulkhead assembly is interposed between the flexitank and the open end of the shipping container, or the door(s) (when the door(s) are in the closed position).

In certain embodiments of shipping container systems in accordance with this disclosure, there may be included a tarp or other flexible material which may be used to pull over one end of the flexitank, as disclosed and illustrated further herein. In certain embodiments the tarp may include two or more straps that may be used to secure the tarp to the container inside wall surfaces and/or the ceiling of the container so that it secures the flexitank, and reduce the up-and-down movement of the flexitank inside the container during shipping. Certain embodiments that include air pillows, as mentioned herein provide additional cushioning and help on reducing the up-and-down movement of the flexitank within the container.

Other embodiments of shipping container systems may include product discharge valves and compression fittings (flanges) as disclosed more fully herein.

### Embodiments Illustrated in the Drawings:

In addition to the specific embodiments referenced above, additional specific embodiments (some of which may also be embodied in the specific embodiments referenced above and vice versa) are illustrated in the drawings (Figures). It is understood, however, that neither the specific embodiments disclosed above, nor the specific embodiments disclosed in the drawings serve to limit or restrict the subject matter covered by the claims, which encompass multiple different embodiments, including some that are not disclosed specifically herein, and also including embodiments that may be developed in the future.

Referring now to FIG. 1, an embodiment (example) of a shipping container system is illustrated. The particular shipping container system 10 illustrated in FIG. 1 includes a number of elements, components and/or features, which are discussed below, and are also illustrated in the other drawings. Although not specifically depicted, it is noted that a truck trailer container (discussed above) can also be used instead of the shipping container 12, and a system that includes the truck trailer container along with some or all of the elements, components and/or features as those discussed below (and in the specific embodiments referenced above) is within the possession of the inventor(s). For example, a rigid truck trailer container can be combined with the same vertical braces, retainers and bulkhead panels that are described herein.

System 10 includes a rigid shipping container 12, and has three vertical walls 14, 16, 18, a horizontal floor (20), an open end with doors 22, 24 that are proximate the open end, which swing on hinges (not illustrated) between open and closed (shut) positions, so that the open end of the shipping container can be closed, and the shipping container configured in a closed position. This particular system 10 also includes the particular sleeve 26 that is also depicted in other drawings herein. Sleeve 26 has a flexible, substantially planar member 34 that may also be referred to as a flexible vertical sleeve side wall (panel) 34, which is a flexible wall (panel) extending along the length of the sleeve 26. Sleeve 26 also has another substantially planar member 36, also referred to as a flexible vertical sleeve side wall (panel) 36, which is a flexible wall (panel) extending along the length of the sleeve 26. The sleeve also has a floor 40, which has lengthwise edges that adjoin and correspond to the lengthwise lower edges of the vertical sleeve side walls (panels) 34, 36. The sleeve 26 also has a flexible rear vertical wall (panel) 38 disposed between and perpendicular to the two vertical side walls (panels) 34, 36. The sleeve also has a flexible front vertical wall (panel) 28, which includes a portion 30 that extends above the upper edges of the other three flexible walls (panels) 34, 36, 38, and this portion 30 operates as a flap, and preferably includes straps 42 for securing the flap over the bulkhead assembly (discussed below). The flexible front vertical wall (panel) 28 of the sleeve includes an aperture, through which a portion of the flexitank discharge valve 56 can protrude. The embodiment 10 of the shipping container system also includes a flexitank 54, which has an aperture that includes a discharge valve 56 (depicted in representational illustrative, non-detailed form) and an aperture that includes an air vent 58. It is noted that the air vent can be located in places other than at the top of the flexitank including, for example, a location next to the discharge valve.

Also included in the specific system 10 depicted in FIG. 1 is flexible cargo net 60, which can be secured at a diagonal orientation to secure the flexitank during transportation. Preferably, the cargo net inhibits upward movement of the flexitank within the rigid container 12 when the rigid container is being transported on a ship and experiences severe wave action, causing the flexitank to roll forward and backward and up and down. The flexible cargo net 60 is illustrated in FIG. 1 as part of an unassembled exploded view of the various components of the specific system 10, but it will be recognized that the cargo net is to be placed so that it secures the flexitank, and has, for example, one edge (the lower edge, which is horizontal and closer to the bulkhead assembly) secured proximate either the top of the bulkhead assembly 68 or midway across the inside of the bulkhead assembly, and can optionally be secured on the inside surface of the flexible front vertical sleeve wall 28. The upper edge of the cargo net can be secured by cords (not illustrated), e.g., one cord that ties the cargo net to one of the sides of the rigid container (e.g., inside of side wall 16) and a second cord that ties the cargo net to another side of the rigid container (e.g., inside of side wall 14). As noted elsewhere herein, the cargo net can be either affixed to the sleeve, or it can form an integral part of the sleeve, e.g., being sewn together with the sleeve or otherwise affixed or adjoined along one edge (preferably the lower edge) to the sleeve. As depicted in the drawings, the cargo net is rectangular, but it is contemplated that a cargo net in which the side farthest away from the doors (e.g., the free or unaffixed side) has a width that is smaller than the width of the cargo net closest to the doors.

The specific system 10 illustrated schematically in FIG. 1 also includes air pillows, which preferably function as cushions against the upward movement of the flexitank against the inside of the top “lid” (not illustrated) of the rigid container. At least one of the air pillows 62 can be placed on top of the cargo net 60, described above. Other air pillows 64, 66, can be placed directly on either side of the upper surface of the flexitank, and those other air pillows also serve as cushions to the upward movement of the flexitank, and also tend to inhibit any rolling movement of the flexitank, e.g., toward and away from the bulkhead assembly. Preferably, the air pillows have valves (not illustrated) where pressurized air can be introduced to the interior of each air pillow, and such air can also be released, e.g., upon arrival of the shipping container apparatus 10 to its destination.

Also illustrated schematically in FIG. 1 is a specific bulkhead assembly 68 which includes two vertical braces 70, 72 and three horizontal bulkhead panels. The vertical braces and the horizontal bulkhead panels are described in greater detail below, with reference to other drawings. The specific horizontal panels in apparatus 10 (which can also be referred to as horizontal reinforcement members) include an upper bulkhead panel 90a, an intermediate bulkhead panel 90b and a lower bulkhead panel 102. The lower panel includes an aperture through which an extending portion of the flexitank discharge valve 56 can pass.

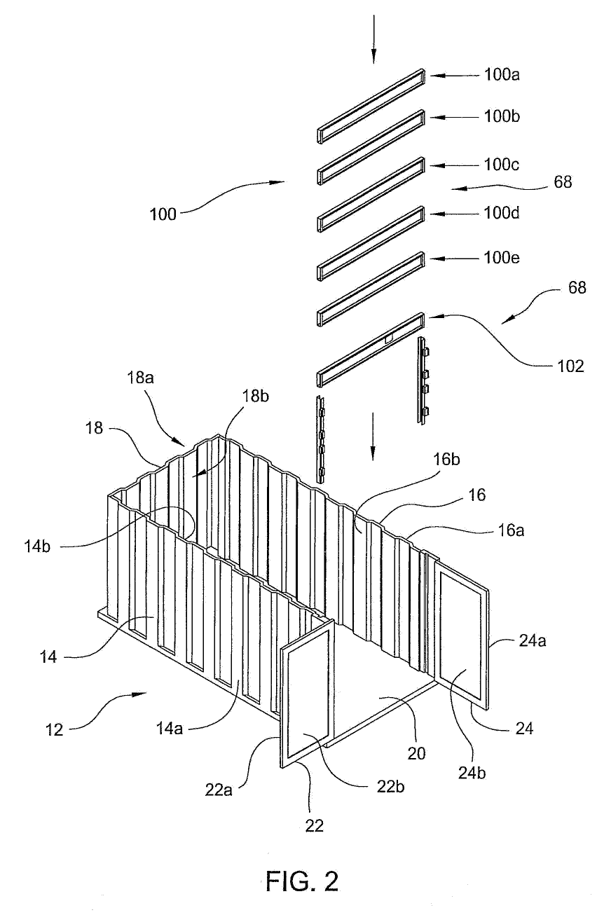

Referring now to FIG. 2, a particular specific embodiment (example) of a shipping container system is illustrated, which includes a rigid shipping container and a bulkhead assembly 68 that has six horizontal bulkhead panels, 100a, 100b, 100c, 100d, 100e and 102. In this particular system 10, the lower bulkhead panel 102 has the same structure and dimensions as the lower bulkhead panel 102 in the apparatus 10 in FIG. 1, but the other bulkhead panels 100 are different from the bulkhead panels 90 in FIG. 1, and it is understood that still other types of horizontal bulkhead panels may also be used, subject to the requirements and limitations specified in any applicable claims. It is also understood that the rigid shipping container in FIG. 2 is the same as, or at least similar to, the rigid shipping container depicted in FIG. 1. Certain details of the rigid shipping container in FIG. 2 will now be described.

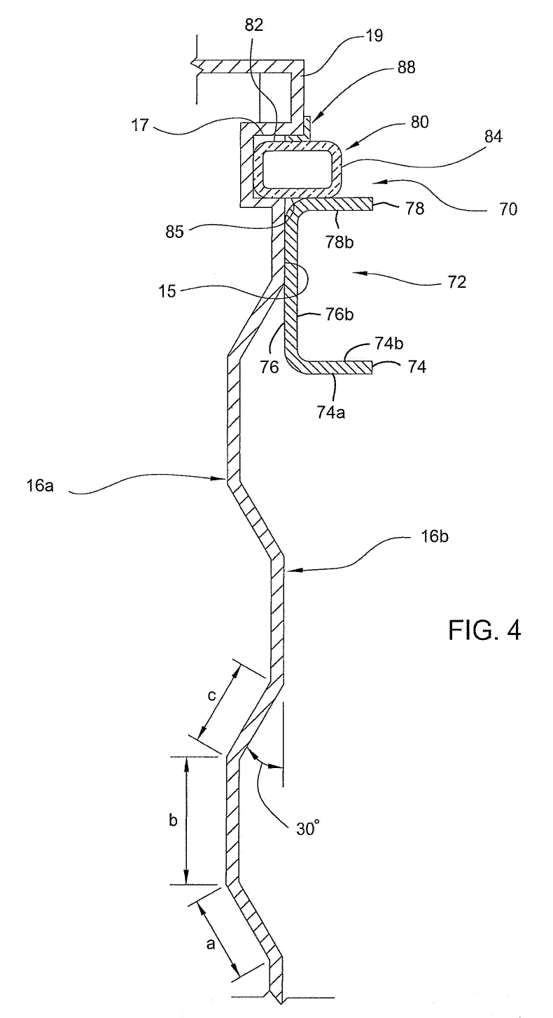

As noted above in reference to FIG. 1, the shipping container of FIG. 2 has three vertical walls 14, 16, 18, which include two facing side walls 14, 16, which extend along the length of the rigid container, and an end wall 18 which is disposed between the two side walls as illustrated in FIG. 2. Each of the vertical walls 14, 16, 18 is described herein as being “substantially planar,” although it is recognized that each of those vertical walls has irregular outer and inner surfaces, which are sometimes referred to as “lazy corrugations.” The overall inner “surface” of each wall 14, 16 and 18 includes individualized component surfaces (sub-surfaces), which are referred to generally herein on occasion as “surfaces.” Those individualized component surfaces (sub-surfaces) can be seen in FIG. 4, from a view looking downward, in the specific context of the vertical wall 16 proximate the open end of the rigid container. The other container walls 14 and 18 have the same, or similar, component surfaces. It can be seen that certain component surfaces are oriented in the same plane as the overall surface (perpendicular to the end wall and the closed doors) while the other component surfaces are oriented at an angle (typically a 30 degree angle) relative to the plane of the overall surface of each vertical wall 14, 16, 18. As discussed below in greater detail, the orientation and arrangement possessed by those component surfaces play an important role in at least certain embodiments of the shipping container apparatus described and/or claimed herein, and also of the bulkhead assemblies, including particularly the vertical braces and/or the vertical retainers. Vertical container wall 14 includes an inner overall surface 14b and an outer overall surface 14a; vertical container wall 16 likewise includes an inner overall surface 16b and an outer overall surface 16a; and vertical container wall 18 also includes an inner overall surface 18b and an outer overall surface 18a. The rigid shipping container 12 in FIG. 2 also includes a “door end,” which absent the doors 22, 24 is open. Each of the doors 22, 24, as described above with reference to FIG. 1, is capable of being in an open position or a closed position. As with the vertical walls 14, 16 and 18, each door 22, 24 has an outer surface 22a, 24a and an inner surface 22b, 24b. The rigid container 12 illustrated in FIG. 2 also includes a floor 20.

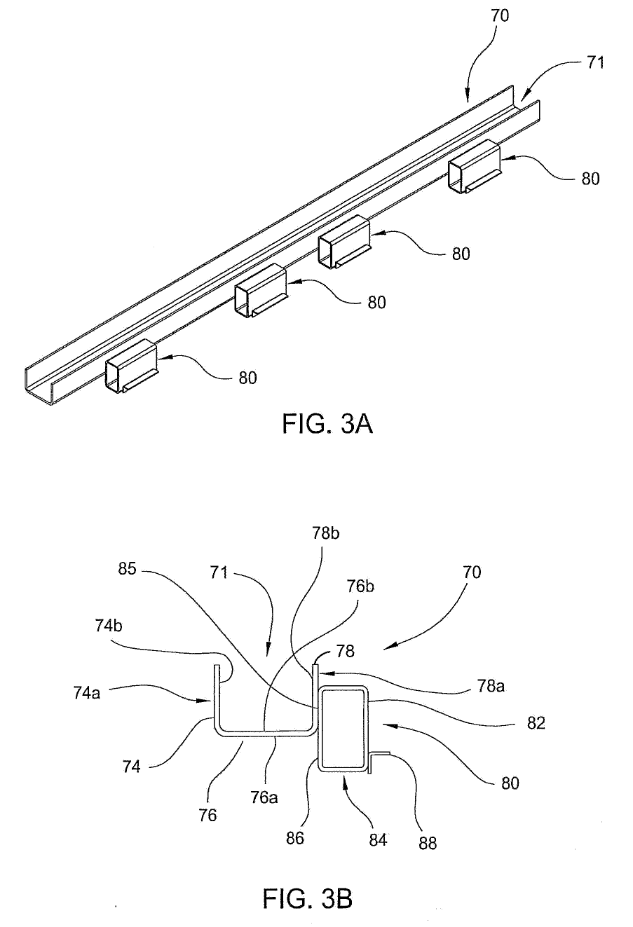

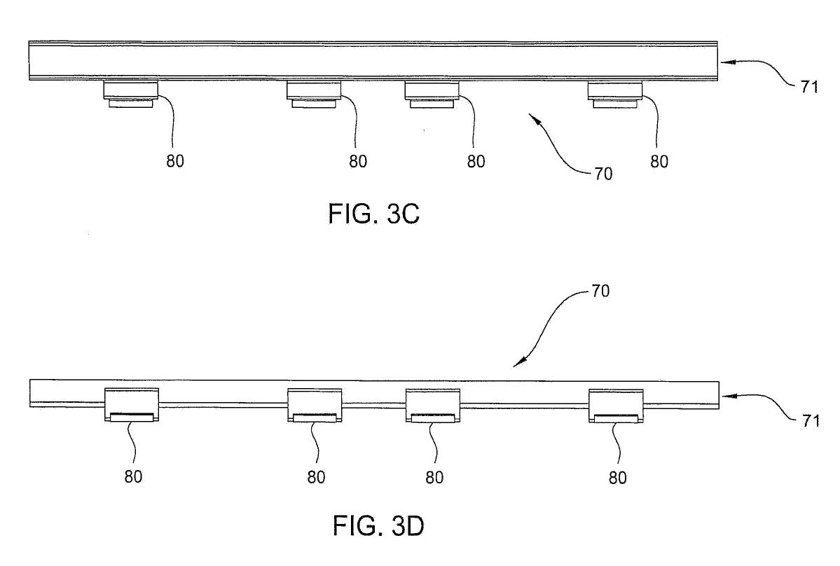

Referring now to FIGS. 3A, 3B, 3C and 3D (collectively referred to as FIG. 3), specific examples of the vertical braces 70, 72 that are illustrated in both FIGS. 1 and 2 are depicted. A perspective view of one of the vertical braces 70 is illustrated in a semi-horizontal position (i.e., not installed in the shipping container apparatus). In the particular example illustrated schematically in those drawings, the vertical brace 70 includes a channel member 71, which is one example of a “primary brace member” referenced elsewhere herein, and one or more “support boxes” 80, each of which is an example of a “secondary brace member” referenced elsewhere herein. The channel member 71 in FIGS. 3A-3D is sometimes referred to as a “C-beam.” As seen in FIG. 3A, the support boxes 80 are each affixed to one of the sides of the channel member 71, and are spaced at irregular intervals, so that they will be more likely to be capable of fitting into the squared lashing channels formed in the inner surfaces 14b, 16b of the rigid shipping container. A top view of one of the vertical braces 70 is depicted in FIG. 3A, which shows the orientation of each of the different components of the vertical brace. Another top view of one of the vertical braces 70 is depicted in FIG. 4, which shows how certain outer surfaces of each vertical brace interact with certain inner surfaces of the rigid container.

The vertical brace 70 illustrated in FIG. 3B includes a channel member 71 which has an inner brace member 74 that is preferably elongated and planar, and is “inner” in the sense that it has an outer surface 74a that faces the rear wall of the rigid container (and the flexitank) when the vertical brace 70 is removably installed in the container, as illustrated in FIGS. 1, 2 and 4. The channel member 71 which has an outer brace member 78 that is also preferably elongated and planar, and is “outer” in the sense that it has an outer surface 78a that faces away from the inner part of the rigid container (and away from the flexitank), and toward the open end of the container (when the doors are opened) and toward the inside surface of the doors (when the doors are closed). The vertical channel member 71 of the vertical brace 70 in FIG. 3B has an intermediate brace member 76 that is elongated and planar, and is “intermediate” in the sense that it is disposed in the space between (or intermediate to) the inner (74) and outer (78) brace members. As depicted in FIG. 4, when the two vertical braces are removably installed in the container, as illustrated in FIGS. 1 and 2, and the bulkhead panels are also removably installed, as illustrated in FIGS. 1 and 2, the two ends of the bulkhead panels push (exert force) outwardly and against the inside surface 76b of the intermediate brace member 76 which results in the transfer of force, and the exertion of outward force by the outside surface 76a of the intermediate brace member 76 against an inside surface 16b of vertical side wall 16 of the rigid container.

As illustrated in FIG. 4, the secondary brace member 80 fits into the lashing channel of the rigid container. The orientation and positioning of the various brace and container surfaces for the structure illustrated in FIGS. 1, 2 and 3 is depicted in FIG. 4. Preferably, as depicted in FIG. 3B, the inner and outer brace members 74, 78 occupy planes that are parallel to one another and perpendicular to intermediate member 76 as well as to the overall surface of the corresponding rigid container side wall. Other views of the vertical brace 70 are seen in FIGS. 3C and 3D, which also show different views of the channel member 71 and the support boxes 80.

Referring again to FIG. 3A, each vertical brace 70 includes in this embodiment one or more support boxes 80, which is a type of secondary support member, each support box 80 comprising an outer box member 82 and an inner box member 85. In alternative structural embodiments the secondary brace members may be structurally different than the support boxes 80. For example, instead of an enclosed box (having four sides) the secondary support member can be a smaller diameter C-beam, in which case the open end of such secondary C-beam faces the same direction as the open end of the primary C-beam. Other embodiments are discussed below. Each of the support boxes 80 illustrated in FIG. 3B includes an inner brace member 85 that is preferably elongated and planar, and is “inner” in the sense that it has an outer surface (see FIG. 4) that faces the inner part of the rigid container (and the flexitank) when the vertical brace 70 is removably installed in the container, as illustrated in FIGS. 1, 2 and 4. Support box 80 in FIG. 3B has an outer lip 88 that is also preferably elongated and planar, and is “outer” in the sense that it has an outer surface (see FIG. 4) that faces away from the inner part of the rigid container (and away from the flexitank), and toward the open end of the container (when the doors are opened) and toward the inside surface of the doors (when the doors are closed). Support box 80 in FIG. 3B has an intermediate brace member 84 that is elongated and planar, and is “intermediate” in the sense that it is disposed in the space between (or intermediate to) inner 85 and outer 82 box members. In certain embodiments, such as illustrated in FIG. 4, when the two vertical braces are removably installed in the container, as illustrated in FIGS. 1 and 2, and the bulkhead panels are also removably installed, as illustrated in FIGS. 1 and 2, the two ends of the bulkhead panels push (exert force) outwardly and against the inside surface 76b of the intermediate brace member 76 which results in both of the support boxes 80 being positioned within the squared channel 17 formed on the inside surface of the rigid container. Each of the support boxes may optionally include lips 88 to provide further support.

In at least one specific embodiment of the shipping container system, as depicted in the drawings, the vertical brace includes an intermediate brace member (exemplified by member 76) that has at least a first and a second portion. The first portion includes an outer surface that is preferably planar and is in contact with a portion of the inner surface of the rigid container, and is also preferably planar. See, e.g., FIG. 4 (element 15). This contact provides for the transfer of forces through at least the first portion of the brace member, in an outward direction, and against the inner surface of the rigid container. Such forces result from the installation of a bulkhead panel, as discussed above. The second portion of the intermediate brace member extends the width of the intermediate brace member so that it can receive and provide support for an end of the horizontal bulkhead panel. In certain embodiments, such as illustrated in the FIG. 3 drawings, the cross-section of the channel member 71 (and, more broadly, the “primary brace member”) is in the shape of a squared C, so that it not only provides for the transfer of forces outwardly from the bulkhead panel to the rigid container walls 14, 16 (i.e., parallel to the major surface of the bulkhead panel) but also secures the bulkhead panel so that the bulkhead panel does not move away from the flexitank, so that the bulkhead panel provides support and containment for the flexitank as depicted in FIG. 7. However, some lateral (outward) movement is expected, and in certain specific embodiments is provided for, e.g., by having braces that have a vertical channel with a width that is larger than the width of the bulkhead panel, so that the outward movement of the bulkhead panel causes the brace to “roll” or rotate slightly away from bulkhead panel, and in the direction of the force(s).

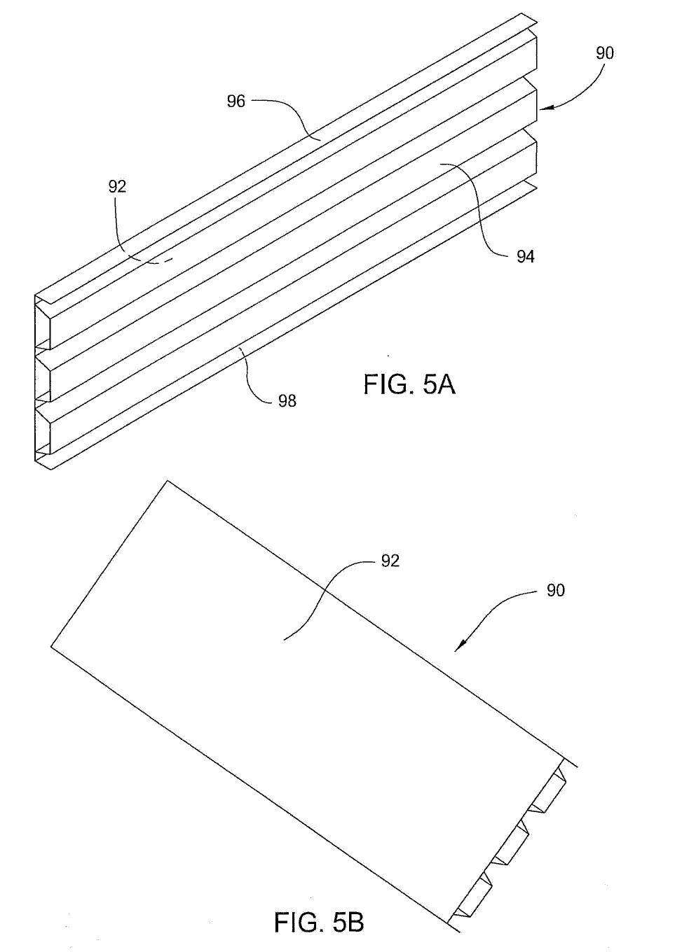

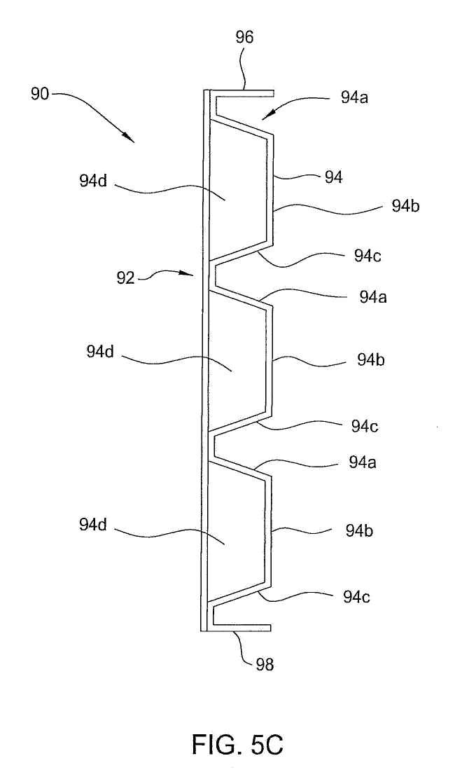

Referring now to FIGS. 5A, 5B and 5C (collectively FIG. 5), a bulkhead panel 90 is illustrated which includes an inner surface 92 (also referred to as an inner bulkhead panel surface) and an outer surface 94 (also referred to as an outer bulkhead panel surface). Generally, the “inner” surface of a bulkhead panel is the surface that faces the rear wall of the container, and the “outer” surface of a bulkhead panel is any surface that faces (squarely or at an angle) the front or door end of the container (recognizing that in certain embodiments outer surface 94 of bulkhead panel 90 may comprise multiple sub-surfaces, only some of which squarely face the front end or the door end, such as illustrated in FIG. 5A). Inner surface 92 is planar and substantially smooth in the embodiment illustrated. In other embodiments, both surfaces may be smooth, or both may be corrugated. During the shipping/transportation process of the shipping container apparatus, the flexitank (when in a filled condition) tends to press against the inner surface 92, and a smooth planar surface tends to effectively absorb and distribute the forces applied against them from the flexitank. Also, because the inner surface 92 is substantially smooth without any protrusions (such as bolts), there is less risk of puncturing the flexitank. The outer surface 94, on the other hand, may be corrugated, with certain surfaces (sub-surfaces 94b) that are coplanar with the inner surface 92 and other, alternating, surfaces (sub-surfaces 94a, 94c) that are not coplanar, but rather lie in a plane that intersects the plane defined by the planar surface of inner surface 92 at an angle that can be approximately 15-30 degrees off perpendicular (as depicted) but can also be perpendicular or somewhere between 30 and 45 degrees off perpendicular (not illustrated). Accordingly, as illustrated in FIG. 5A, the horizontal bulkhead panel member 90 (also referred to more generally as a bulkhead panel) includes a series of squared-sided tubes (defined on one side by 94a, 94b and 94c) with an interior 94d, such that the tubes each extend lengthwise and horizontally, which creates a structure that is both strong and sufficiently lightweight so that, during installation, the bulkhead panel can be easily lifted by one or two persons and placed between two vertical braces and within the channels defined by the vertical braces, as depicted in FIG. 1. Referring to FIG. 5C, each bulkhead panel also has a top surface 96 and a bottom surface 98. As seen in FIG. 1, the bulkhead assembly preferably includes at least two bulkhead panels (i.e., an upper bulkhead panel and an intermediate bulkhead panel) that are identical and are depicted in FIG. 5. The upper bulkhead panel has a lower surface 98 that is placed in adjoining relation to the top surface 96 of the intermediate bulkhead panel, which thereby supports the upper bulkhead panel. Preferably, both the upper bulkhead panel and the intermediate bulkhead panel have top and bottom surfaces 96, 98 that are flat and parallel with the floor of the rigid container.

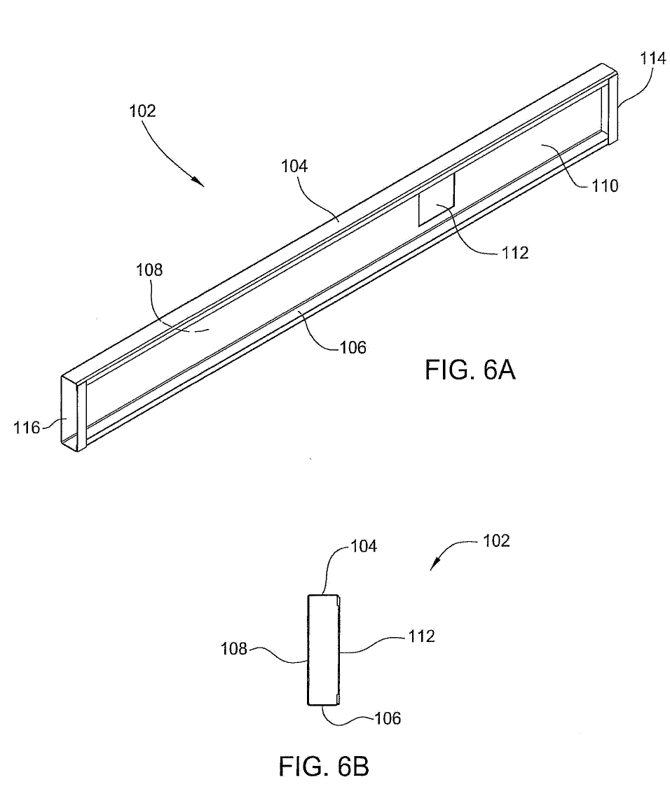

In another specific embodiment, illustrated in FIG. 2, a bulkhead assembly includes a plurality of (multiple) horizontal bulkhead panels 100 (100a, 100b, 100c, 100d, 100e) that each have a different shape, configuration and size than the shape, configuration and size of the bulkhead panels 90 depicted in FIGS. 1 and 5. Those bulkhead panels 100 preferably have the same size, shape and configuration as the lower bulkhead panel that is depicted in FIGS. 1 and 6 (FIGS. 6A, 6B, 6C and 6D), discussed below, except that those bulkhead panels 100 do not have an aperture 112 through which the discharge valve member protrudes. There are more individual bulkhead panels 100 in the bulkhead assembly of FIG. 2 than there are individual bulkhead panels 90 in the bulkhead assembly of FIG. 1, but those bulkhead panels share some of the same benefits when installed, i.e., they form a bulkhead panel “wall” (barrier) that effectively separates the flexitank from hitting against the inside surfaces of the closed container doors. As with the bulkhead panels 90, the bulkhead panels 100 include an upper (or top) bulkhead panel 100a and intermediate bulkhead panels 100b, 100c, 100d, 100e. The bulkhead panels 90, and also the bulkhead panels 100, each form a solid bulkhead “wall” (barrier), as contrasted with horizontal reinforcing bars, which leave spaces between them so that an additional flexible sheet is used to provide a barrier.

Referring now to FIGS. 6A, 6B, 6C and 6D (collectively, FIG. 6), panel 102 is depicted, which is a specific example of a lower bulkhead panel, and this same panel 102 is part of the bulkhead assembly (and the shipping container system 10) illustrated schematically in FIG. 1 as well as the bulkhead assembly and the shipping container system 10 illustrated schematically in FIG. 2. As illustrated in FIG. 6A, each of those lower bulkhead panels 102 includes a top surface 104, which supports one of the intermediate bulkhead panels 90 or 100; a bottom surface 106, which preferably rests on the rigid container floor; an inner surface 108, which is planar and smooth, like the inner surface of the upper and intermediate bulkhead panels, and preferably lies in the same plane as the inner surface of the upper and intermediate bulkhead panels to form a single bulkhead wall surface; an outer surface 110, which is set back away from the outer edges of the top and bottom surfaces 104, 106. The aperture 112 in the lower bulkhead panel occupies a plane that is separated from the plane defined by the inner surface of the lashing channel closest to the rear wall by more than 2 inches, and preferably by from 2 to 5 inches. Surprisingly, it has been discovered that the location of the plane of the aperture has a benefit, namely, it reduces the occurrence of leakage which has been a serious problem experienced in earlier shipping container apparatus. At least one of the inventors herein has recognized that, in the specific embodiment illustrated in FIG. 6, the relatively large distance between the plane of the aperture in the bulkhead panel leads to less of a risk that any part of the protruding discharge valve member will be pushed against the inside surface of the door during shipping, including the valve handle, resulting in less of a likelihood that the valve handle will be inadvertently opened, which can result in leakage.

Accordingly, referring to FIG. 6A, the lower bulkhead panel has an upper surface 104 that is in supportive contact with a lower surface of one of the intermediate bulkhead panels (discussed above). The width of surface 104 is preferably 3 inches or greater, so that the surface provides support for the intermediate bulkhead and, also, so that the location of the plane of the aperture 112 is set far enough back from the door, as noted above. The bulkhead panel 102 has panel ends 114 and 116 that are sized to fit into the corresponding vertical channels of the braces, discussed above. The bulkhead panel 102 has a substantially smooth internal (inside or inner) surface 108, which is continuous except for the aperture 112. In at least one specific embodiment, small openings (not illustrated) are formed on either side of the aperture to receive bolts that support a fitting (not illustrated) for the discharge valve of the flexitank.

Shipping container apparatus 10 is depicted in FIG. 7, in at least a partially-assembled form or condition (except that the flexitank discharge valve member is not illustrated). For example, the sleeve is illustrated as having been placed in the rigid container. The flexitank (minus the discharge valve member) is illustrated as having been placed in the rigid container; the two vertical braces are in place; the lower bulkhead panel is installed between the two vertical braces; the intermediate bulkhead panel is in place above and resting on top of the lower bulkhead panel; and the upper bulkhead panel is in place above and resting on top of the intermediate bulkhead panel. The flap 30 of the flexible sleeve is in a position so that it can be pulled downward and tied off using the straps/cords 42. The largest main air bag 62 is placed on top of a portion of the flexitank proximate the container doors and bulkhead. The smaller side air bags 64, 66 are each placed on one of the upper side surfaces of the flexitank occupying the space above the flexitank and providing cushion in addition to that provided by the main air bag.

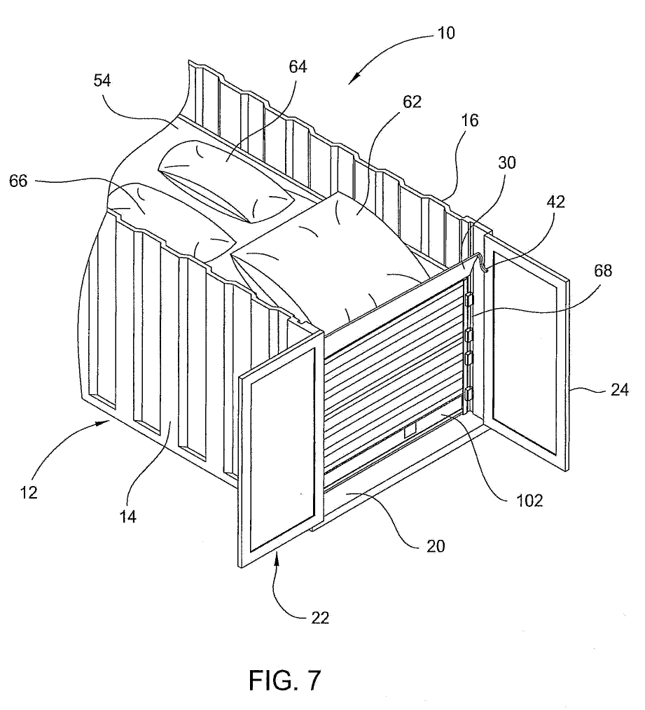

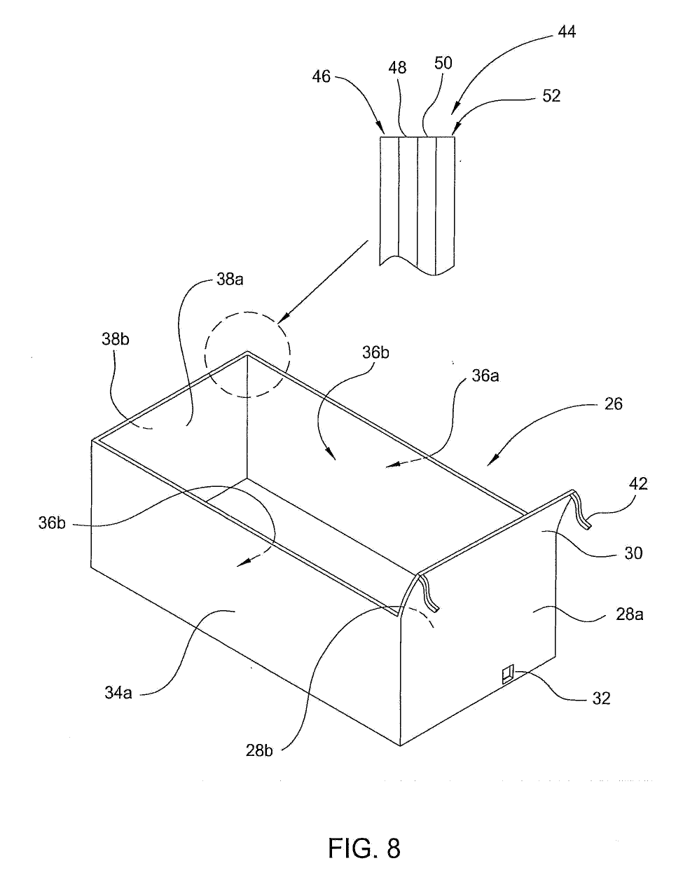

An example (specific embodiment) of a flexible sleeve 26 is depicted in FIG. 8. Sleeve 26 is also depicted in FIG. 1 as part of a shipping container system. That particular flexible sleeve 26 has one rectangular floor and four rectangular walls that are substantially vertical, specifically two side walls 34, 36 with inside surfaces that are coplanar and face one another and two end walls (panels) 28 38 that are coplanar and face one another. Side wall (panel) 34 has an inside (inner) surface 34b which is rectangular and substantially planar (preferably having a smooth surface), and also an outside (outer) surface 34a which is also rectangular and substantially planar (and preferably also has a smooth surface). Likewise, side wall (panel) 36 has an inside (inner) surface 36b which is rectangular and substantially planar (preferably having a smooth surface), and also an outside (outer) surface 36a which is also rectangular and substantially planar (and preferably also has a smooth surface). End wall (panel) 38 has an inside (inner) surface 38b which is rectangular and substantially planar (preferably having a smooth surface), and also an outside (outer) surface 38a which is also rectangular and substantially planar (and preferably also has a smooth surface). Finally, end wall (panel) 28 has an inside (inner) surface 28b which is rectangular and substantially planar (preferably having a smooth surface), and also an outside (outer) surface 28a which is also rectangular and substantially planar (and preferably also has a smooth surface). End wall (panel) 38 is considered the back end or rear end wall, while end wall (panel) 28 is considered the front end wall. In sleeve 26, front end wall (panel) 28 has a height greater than rear end wall 38, and the upper portion of front end wall (panel) 28 is a flap 30, which has two straps or cords 42. As illustrated in FIG. 7, the two side walls (panels) of the sleeve and the rear end wall of the sleeve have the same height, which height is less than the height of the vertical walls of the rigid container. Each of the flexible walls (panels) (and also the floor panel) of the sleeve is preferably a laminated composite sheet composed of at least three individual sheets laminated together.

As illustrated in FIG. 8, the laminated composite sheet can be composed of four individual sheets. The outer sheet 52 is preferably a durable, woven polypropylene sheet. One of the intermediate sheets, preferably the outermost intermediate sheet 50, is preferably a layer of any material that is vapor-impermeable, or substantially vapor-impermeable. In a preferred embodiment, the outermost intermediate sheet 50 is an aluminum foil. Another intermediate sheet, preferably the innermost intermediate sheet 48, is preferably made of polyethylene, or includes polyethylene; and the inner sheet 46 may in some embodiments comprise an absorbent material, such as a layer of felt or other liquid absorbent. However, in other specific embodiments, the layers may be arranged differently. For example, in certain embodiments, the outer sheet or layer is foil, since it can more easily be applied to a woven polypropylene sheet (also referred to as a liner or layer), which in that embodiment is the outermost intermediate layer. In a version of the composite sheet having only three layers, the outer sheet may be woven polypropylene; the intermediate sheet may be nonwoven polyethylene and the inner sheet may be absorbent. The absorbent layer (which includes any absorbent-containing layer) can have any of a variety of different thicknesses. In certain embodiments, however, the thickness will range somewhere between 1 mm and 10 mm. A surprising benefit of an absorbent layer is that it is capable of absorbing any liquids that escape from the inside of the flexitank, and also causing a wicking of the liquids so that they do not accumulate in a single location, e.g., forming a pool

The sleeve can be made using conventional laminating technology, and all the components, i.e., the different layers, can be also made individually using conventional technology. The sleeve can be constructed by using a single-piece tubing composed of multiple layers that are laminated together. The sleeve is then cut along the length to form half a tube, then it can be folded to form square edges joining a floor with two side walls. Then end walls are added, first, by heat-fusing a rear end wall to the opening separating the two side walls at the back or rear and, then, by heat-fusing a front end wall to the opposite opening. Straps (not illustrated) can be added to the upper edges of the sides of the sleeves to secure them to the inside of the rigid container.

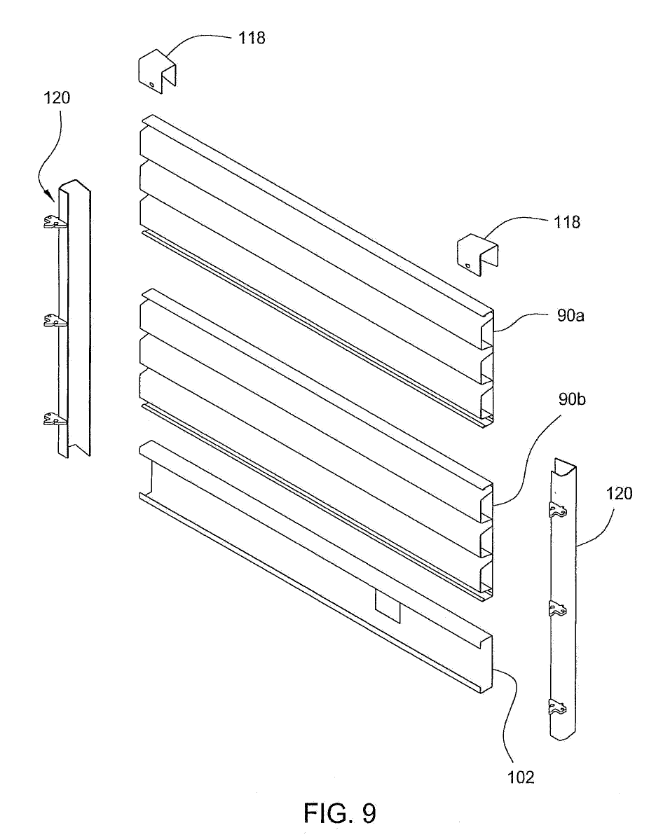

Referring now to FIG. 9, a specific embodiment of a bulkhead assembly 68 is depicted, which can be used in the place of the bulkhead assembly 68 depicted in FIG. 1. Certain elements are the same, namely, the lower bulkhead panel 102 and the upper and intermediate bulkhead panels 90a, 90b. But in FIG. 9, different braces are used than the braces 70, 72 in FIG. 1. Specifically, the bulkhead assembly in FIG. 9 includes braces 120, which have channels that are sized and shaped differently than the channels of braces 70, 72. As with braces 70,72 each of the two ends of each bulkhead panel 90a, 90b and 102 fit into the channels of the braces, and are thereby supported laterally, meaning that the bulkhead panels are restrained from undue forward and rearward movement. Each bulkhead panel is supported vertically by the surface of the immediately adjoining structure below that panel. For example, the lower bulkhead panel is supported by the container floor, the intermediate bulkhead panel is supported by the upper surface of the lower bulkhead panel, and the upper bulkhead panel is supported by the upper surface of the intermediate bulkhead panel. In at least the embodiment illustrated in FIG. 9, bulkhead panel clamps 118 are depicted, which can include apertures (openings) to receive bolts or pins to secure the bulkhead panels. As illustrated in FIG. 9, the bulkhead assembly faces the container doors, with the rear wall facing into the page (albeit at an angle).

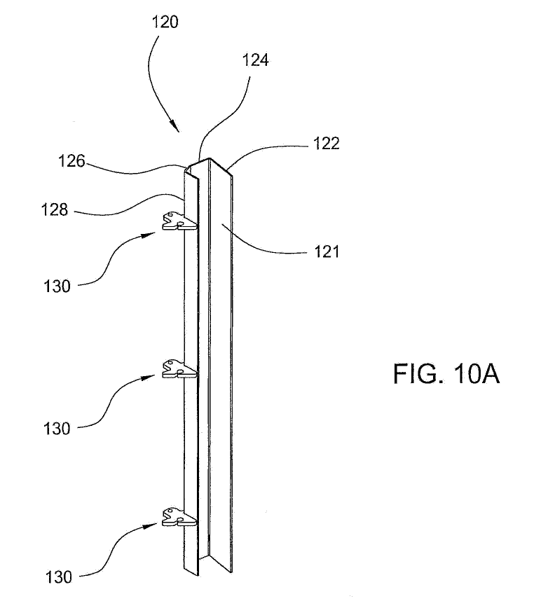

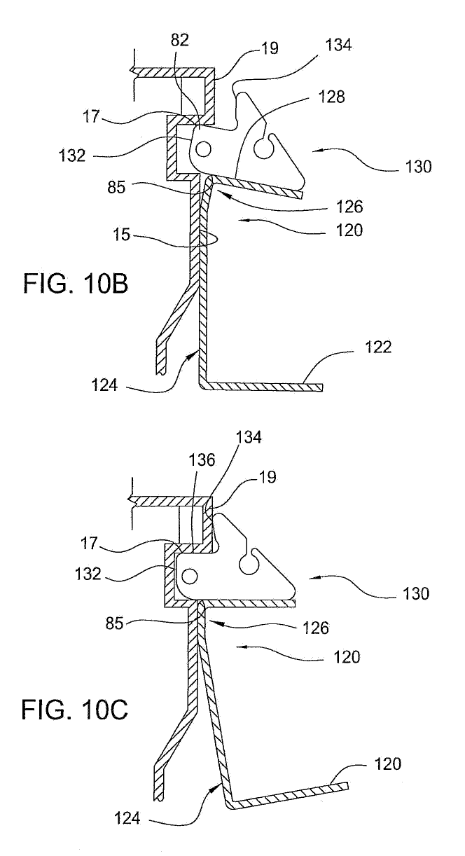

Referring to FIG. 10A, an isometric view of the brace 120 is illustrated. Brace 120 comprises, in this embodiment, a channel, defined by four elongated surfaces, i.e., sub-surfaces of the overall inner surface of the brace, which in at least the embodiment illustrated in FIG. 10A define the vertical channel. Two elongated members (sub-members) provide surfaces 122, 128 that face one another, albeit they are not strictly coplanar, as revealed in FIGS. 10B and 10C but rather are slightly canted with respect to one another. An intermediate member joins the sub-members, and this particular intermediate member is composed of two sub-members, which provide two sub-surfaces 124, 126. The structure 120 is described above as being composed of various elongated sub-members, but it is understood that structure 120 is a unitary steel beam that is formed to provide surfaces (sub-surfaces) 122, 124, 126, 128, which together define the vertical channel for the brace. Also depicted in FIG. 10A are three secondary brace members 130, which are described in greater detail in connection with FIGS. 10B and 10C.

FIGS. 10B and 10C are top-views of one of the braces 120, illustrated juxtaposed against the inner surface of a rigid container, proximate the open end where the doors are located. It will be recognized that the dimensions of the inner surface(s) of the rigid container are approximate only, since shipping containers often vary in individual dimensions. Nevertheless, one of the benefits of the bulkhead assembly generally disclosed herein is that it can be used with a variety of different types of rigid containers, and that it accommodates the many different sizes and features found in those rigid containers. Referring now to FIG. 10B, the vertical brace is depicted in an “open” or “unlocked” position. The primary brace member 120 provides a vertical channel on the side that is defined by the various surfaces (sub-surfaces) of members (sub-members) 122, 124, 126, 128. As discussed above, one end of the horizontally disposed bulkhead panel fits into the vertical channel, and the distance between the outer edge of the primary brace members 122, 128 is sufficient to accommodate the width of the bulkhead panel. It can be seen from the drawings that the members 122, 128, slant outwards in the direction of the adjoining intermediate members 124, 126, so that the distance between the adjoining edges of members 122, 128 is greater than the distance between the outer edges of those same planar members. A surprising benefit of this design of the brace is that, when the vertical brace is shifted from an “open” or “unlocked” position (FIG. 10B), to a “closed” or “locked” position (FIG. 10C), the inside surface of member 122 clamps against the inner surface of the bulkhead panel.

Referring now to FIG. 10B and FIG. 10C, it is seen that the intermediate portion that couples, adjoins or connects the two members 122, 128 include two members 124, 126, which can also be referred to as sections, or parts, or portions. Advantageously, the outer surface(s) of those members 124, 126 are canted with respect to one another, namely, they lie in different planes. One of the planes (the largest one) is defined by the outside surface of section 124. When the brace is in an “open” position (FIG. 10B), that outside surface of section 124 preferably abuts against one of the inside surfaces 15 of the rigid container. When the brace is shifted to a “closed” position (FIG. 10C), which preferably occurs after the bulkhead panels are installed, the brace 120 rotates forward (toward the doors) and the outside surface of section 126 abuts against that same inside surface 15. Thus, there is at least one advantage to a brace with an intermediate member that has an outer surface that is not part of the same plane. In another specific embodiment (not illustrated), the outer surface of the intermediate member is arc-shaped, in the nature of a cam, so that the vertical brace can roll or shift forward, and still provide contact between the outer surface of the vertical brace and one of the inside surfaces of the container.

Another feature of the brace 120 illustrated in FIGS. 10B and 10C is the secondary brace member 130. As noted above, at least one other specific embodiment of the brace includes secondary brace member 30 that is box-shaped, as seen in FIGS. 1 and 3. The particular secondary brace member 130 demonstrates that other structures can alternatively be used instead of the box-shaped structure 30 in FIG. 3, and it is recognized that other structures, which are not specifically depicted herein, can likewise be used, all within the scope of the claim, provided the other limitations of the claim are met. The secondary brace member 130 in FIGS. 10B and 10C is affixed to the primary brace member 120 which includes sub-members 122, 124, 126, 128, preferably on one side of the brace member, e.g., to the outer sub-member 128.

The secondary brace member 130 preferably includes a protrusion that fits into the lashing channel, in the same way that the box-like secondary brace structure fits into the lashing channel. With respect to secondary brace member 130, the protrusion preferably includes a first (preferably outer-directed) surface 136, which abuts against the outermost surface of lashing channel 17, and thereby provides support against movement of the bulkhead panels toward the doors. For member 130, the protrusion can also include a second surface 132 which, when the bulkhead assembly is in a closed or locked position (see FIG. 10C), can abut and be in physical contact with and against the surface of the intermediate portion of the lashing channel 17, i.e., the surface of the lashing channel that is parallel with the length of the container and perpendicular with the open end and/or the closed doors and forms the “bottom” of the lashing channel. This abutting relationship is seen in FIG. 10C. However, in a preferred embodiment, it is recognized that rigid containers have many different dimensions and their lashing channels also have slightly different dimensions. Therefore, the length of the protrusion portion of secondary brace member should be sufficiently long to accommodate different types of containers and lashing channels, by providing support in both an open and closed position, but not so long that the surface 134 (discussed below) is not capable of making contact when the assembly is in a closed or locked position. In a preferred embodiment, the secondary brace member preferably includes the two surfaces mentioned above, and also a third surface, depicted in FIGS. 10B and 10C as surface 134. When the brace is in an open position (FIG. 10B), the surface 134 is not in physical contact with the container. However, when the brace rolls to a closed position (FIG. 10B), the surface 134 abuts against the side of the container, at surface 19, and thus prevents the brace from rolling forward. This surface 134 thus serves a similar purpose and function as the lip 88 in secondary brace member illustrated in FIG. 4.

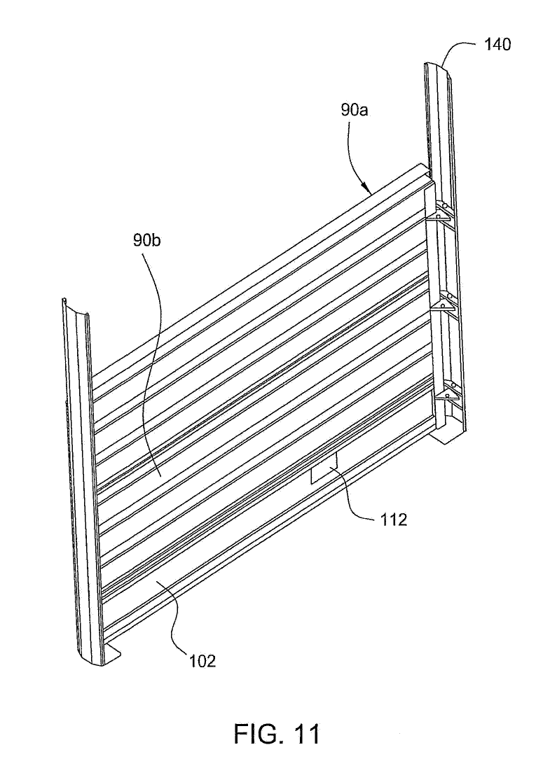

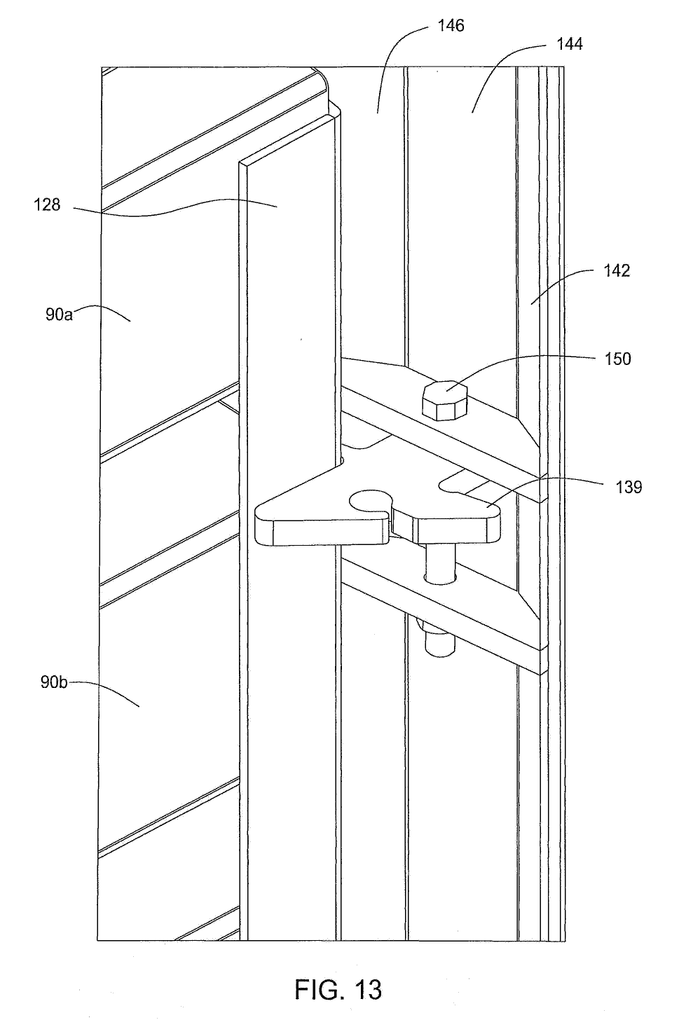

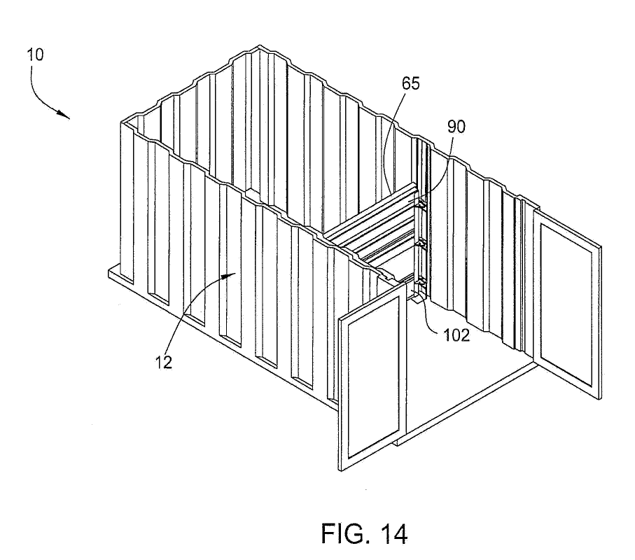

Now referring to FIG. 11, an example (specific embodiment) of an intermediate bulkhead assembly is illustrated, which includes not only the lower bulkhead panel 102 (described above) but also the upper and intermediate bulkhead panels 90a, 90b. This intermediate bulkhead assembly includes a brace that is identical to the brace described above, with reference to FIGS. 10A, 10B, and 10C. Advantageously, the same brace and bulkhead panels that are used in the forward bulkhead assembly can be used in the intermediate bulkhead assembly. The intermediate bulkhead assembly fits into the container at an intermediate point, as depicted in FIG. 14. In at least one specific embodiment, however, the intermediate bulkhead assembly also includes a pair of retainers 140 and pins or bolts 150, securing the braces to the retainers. FIG. 13 shows an isometric view of the upper part of the retainer showing how it interacts with both the inner surfaces of the wall of the rigid container and the vertical brace.

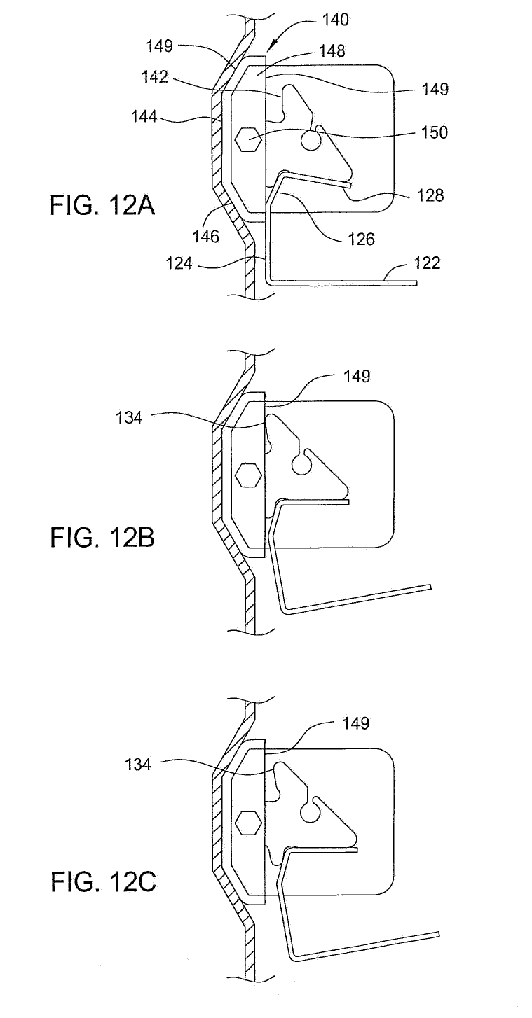

Referring to FIGS. 12A, 12B, 12C, a top view of one side of a specific embodiment (example) of an intermediate bulkhead assembly is illustrated. FIG. 12A shows the assembly in an “open” position. FIG. 12B shows the assembly in a “closed” position, where there is abutting contact between surface 134 and surface 149 of retainer. Now referring to FIG. 12A, the relationship between the brace, retainer and inside surfaces of the container walls is seen. The retainer is elongated and preferably includes at least three different elongated outer sub-surfaces 142, 144, 146, which lie in different planes, and which preferably correspond (e.g., fit against in abutting relation) to the inner sub-surfaces of a typical container, identified elsewhere herein as “lazy corrugations,” and illustrated above in FIGS. 12A, 12B, and 12C. Alternatively, the outer surface of the retainer can be arc-shaped (not illustrated), but it should preferably fit or nest into one of the indentations in the inner surface of a container. The retainer also includes a structure that includes an aperture or opening to receive a bolt or pin 150, so that the brace can be rotatably affixed to the retainer. During installation, the retainers are removably installed, preferably by hand, by leaning each retainer against a selected portion of the inside of the container. Then the vertical braces are placed into the appropriate position, as depicted, and elongated members (e.g., bolts or pins) are placed so that the braces are secured, wherein the secondary brace members can rotate freely around the elongated members (bolts or pins). Each of the two braces are moved to an open position, and each of the bulkhead panels (e.g., lower, intermediate, and upper) are installed by sliding each of them at their ends down the vertical channels of the braces. Once the bulkhead panels are in place, the assembly can be closed or locked by pushing the panels in the direction of the door, so that surface 122 of brace digs into the inner surface of the panel (not illustrated).

FIG. 15 is an exploded perspective view of a generally curved bulkhead bar 200 installed in a container 12 in accordance with one embodiment of the disclosure. Embodiment 200 of generally curved bulkhead bar has a generally B-beam cross-section, with first and second crimped ends 202 and 204. Generally curved bulkhead bar 200 first and second ends 202, 204 are crimped so that they slidingly and removably fit into corresponding lashing channels 17a and 17b of container 12.

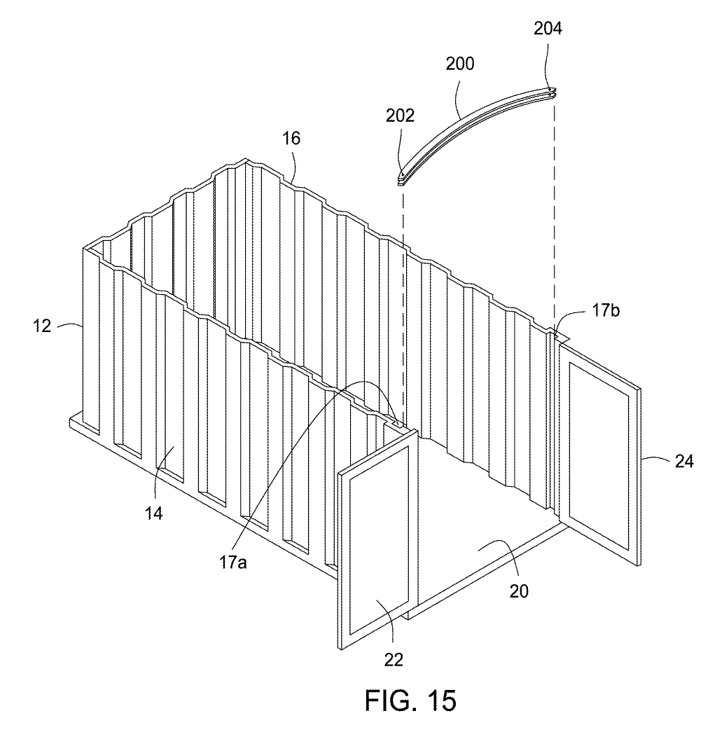

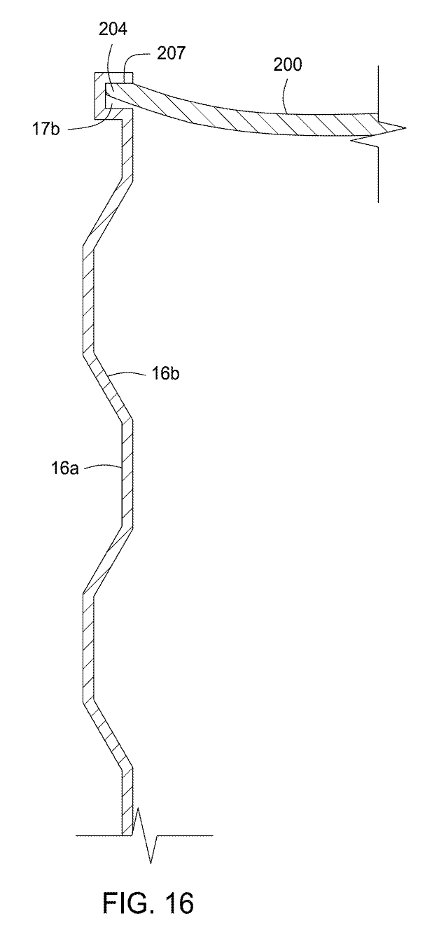

FIG. 16 is a cross-sectional view of one end 204 of generally curved bulkhead bar 200 of FIG. 15 installed in a lashing channel 17b of vertical side wall 16 of container 12. Here it may be seen that, at least in this embodiment, bulkhead bar 200 need not require use of a vertical brace in order to be installed in lashing channel 17b. As illustrated in FIG. 16, and in FIG. 19, which is a more detailed perspective view of generally curved bulkhead embodiment 200, in this embodiment the generally curved bulkhead bar has crimped end areas 207 in order that the ends of bulkhead bar 200 fit into lashing channels 17. It is perceived that crimped end areas 207 may not be required in all embodiments. The need will depend both on the degree or radius of curvature of the bar, and the width of lashing channels 17.

The degree of curvature of generally curved bulkhead bar 200 may vary widely, but generally will be more curved when greater force resistance is desired and less curved when less force resistance is desired. In other words, referring to FIG. 19, as distance D measured from an imaginary line L to the bar 200 increases, bar 200 will probably be able to withstand greater force F, and as the distance D decreases toward zero bar 200 will most likely be able to resist less force F. Force F, depicted by arrows F, is from the movement of a flexitank in the direction of the arrows F. However, as the force resistance increases, the curved length (measured along the curve) will be greater, requiring more metal, and may require other modifications to the ends 202 and 204, such as straightening a portion of the ends, say from 6 to 12 inches away for the tips, in order that they are able to fit into lashing channels 17. In certain embodiments, the lashing channels themselves may be modified, but normally the flexitank supplier has no control over the construction details of the containers 12.

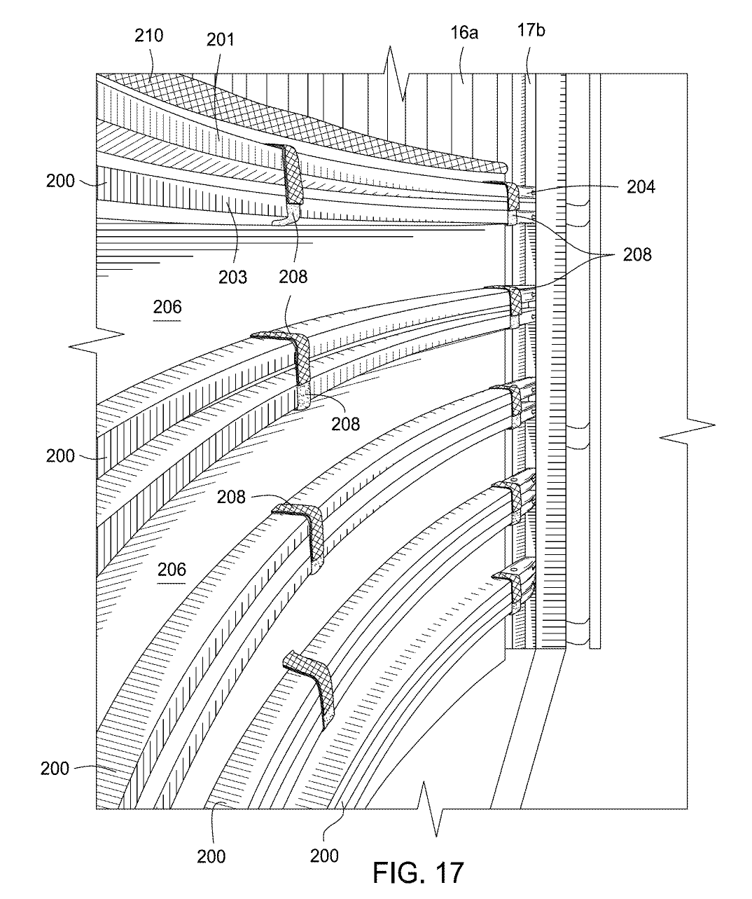

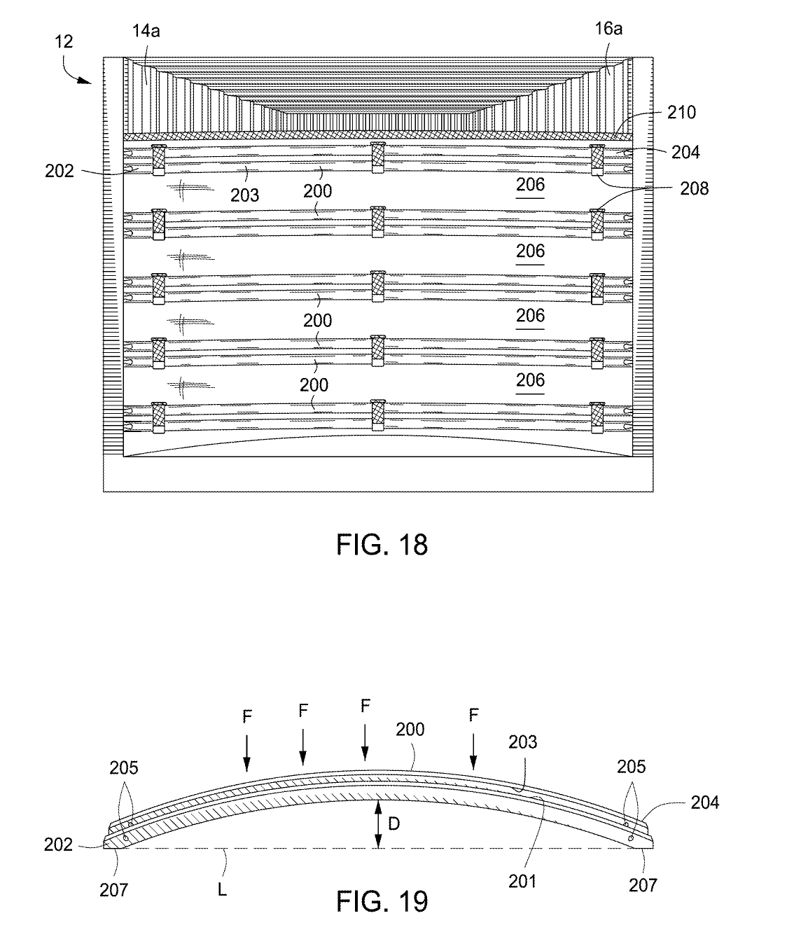

FIG. 17 is a perspective view, and FIG. 18 is a rear end elevation view of five generally curved bulkhead bars 200 like those illustrated in FIGS. 15 and 16 installed in a container 12 in accordance with one embodiment of the disclosure. In this embodiment a flexible bulkhead panel 206, which may be one or more pieces but in this embodiment is a single piece of flexible plastic material, includes fasteners (straps) 208 in strategic locations. In this embodiment each fastener 208 actually consist of a pair of overlapping straps of a hook and loop fastener such as available under the trade designation VELCRO®, one strap having one of its major surfaces comprising a plurality of hooks, and the other strap having a mating plurality of loops on one of its major surface. Flexible bulkhead panel 206 comprises, in this embodiment, a corrugated plastic structure about 0.25 inch thick, but this thickness may be less or greater as desired. As may be seen in the schematic perspective view of FIG. 17, fasteners 208 serve the dual functions of holding the flexible bulkhead panel 206 snugly against the convex side of each generally curved bulkhead bar 200, and to hold each generally curved bulkhead bar 200 in place vertically in lashing channels 17.

An additional feature of some shipping container embodiments is illustrated in FIGS. 17 and 18, the provision of a protective net or other fabric 210. This fabric is stitched, glued or otherwise adhered to a region near the top of the flexible bulkhead panel 206, in some embodiments stitched or glued (or both) to an upper region of a flexible bulkhead panel 206. Most of protective fabric 210, only a portion of which is illustrated in FIGS. 17 and 18, lies over and or slightly above a flexitank (not illustrated).

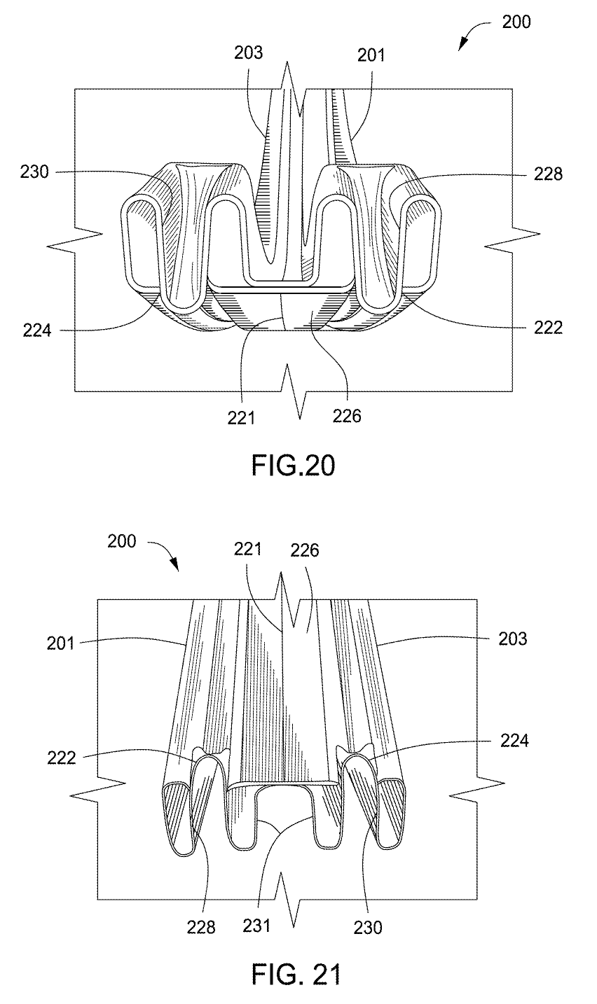

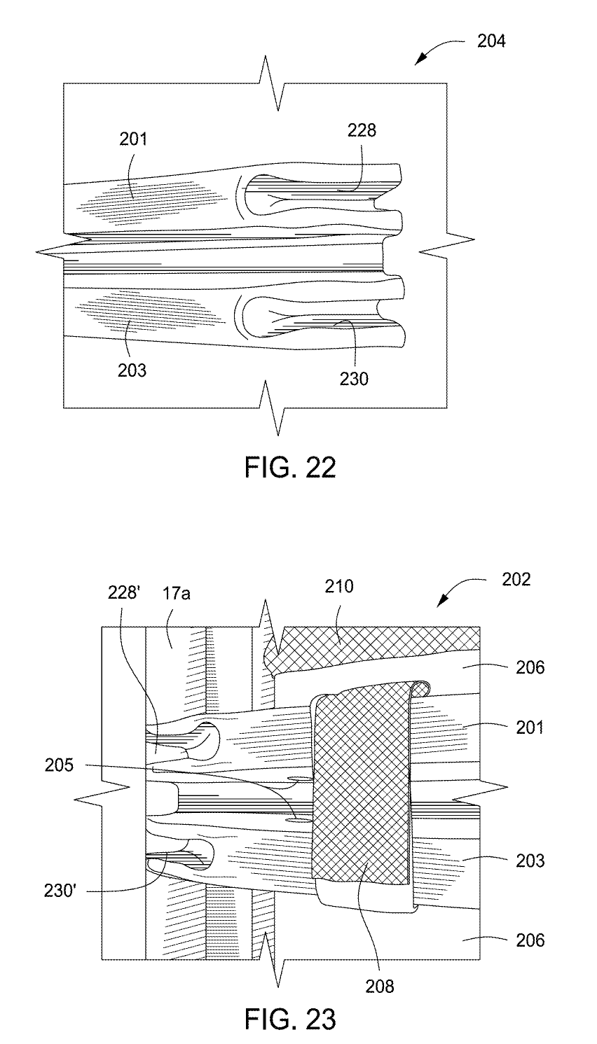

FIGS. 20 and 21 are end elevation, partially perspective views of generally curved bulkhead bar embodiment 200 in accordance with the disclosure, illustrating the B-beam cross-section and more detail of the crimped ends. FIGS. 20 and 21 illustrate that the generally curved bulkhead bar 200 is, in this embodiment, a single piece of thin steel, bent or formed or rolled into a B-beam shape, and then welded at line 221. On the convex side of the B-beam is illustrated weld 221, and a generally flat surface 226 bisected by weld 221. Weld 221 not only welds together the two longitudinal edges of the steel sheet which meet at line 221, but also welds the flat area 226 thus formed to the U-shaped mid-section 231 of bar 200. The two “lobes” 201 and 203 of B-beam shaped bar 200 are on the concave side of the generally curved bulkhead bar 200 (FIG. 19-21). Two cut-outs 222 and 224 (best seen in FIG. 21) are made in the lobes 201, 203 (respectively) at the ends of bar 200, on the flat sides of lobes 201 and 203, respectively, as illustrated in FIGS. 20 and 21. The metal is then crimped at 228 and 230, so that crimp 228 protrudes through cut-out 222, and crimp 230 protrudes through cut-out 224, as illustrated. This cutting and crimping was originally carried out merely so that the ends 202, 204 of the generally curved bulkhead bars 200 would fit into lashing channels 17a, 17b of a container 12. Surprisingly, it has also been found that the crimping provides an additional level of strength for the generally curved shaped bars. This was unexpected. FIG. 22 is a plan view of end area 204 of the generally curved bulkhead bar 200 illustrated in FIGS. 15-21, illustrating more clearly crimps 228, 230. FIG. 23 is a perspective view of the end 202 opposite the end 204 illustrated in FIG. 22 of the generally curved bulkhead bar 200 installed in a lashing channel 17a of a container 12 in accordance with the disclosure. This view illustrates in more detail the relationship of lashing channel 17a, crimps 228′ and 230′, flexible bulkhead panel 206, and fastener 208 in one embodiment.

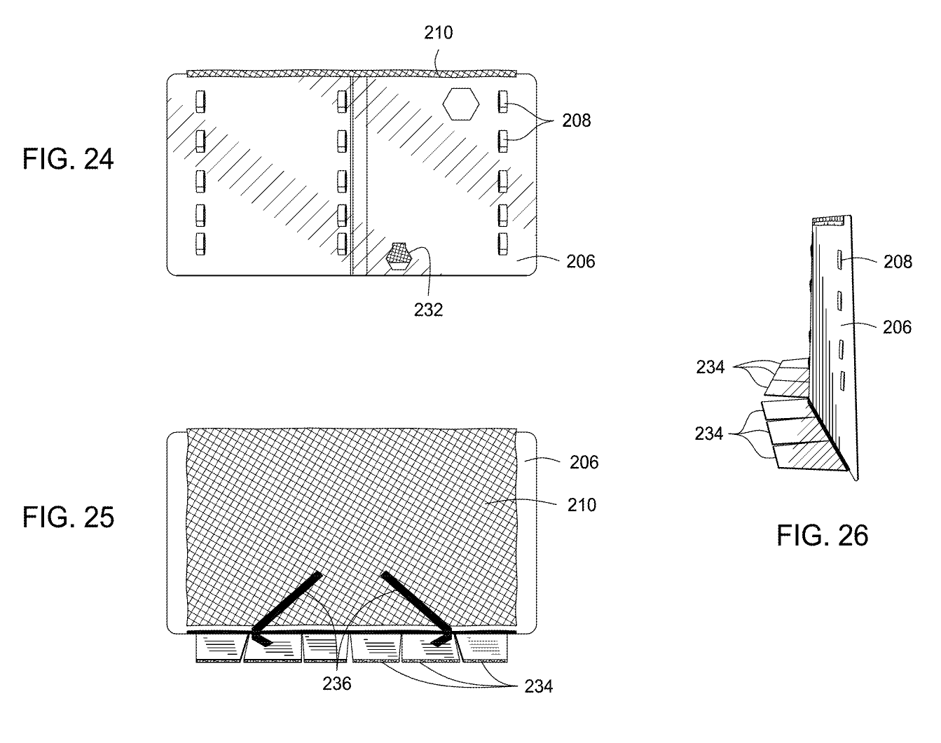

FIGS. 24, 25, and 26 are rear, front, and side elevation views, respectively, of one embodiment of a flexible bulkhead panel 206 in accordance with the disclosure, as used in the embodiment illustrated previously in FIGS. 17,18, and 23. The nomenclature “rear” and “front” is used for convenience only and may be reversed. The term “rear view” is used here to signify that we are viewing that major surface of a flexible bulkhead panel facing the rear doors of a container, and the term “front view” is used here to signify that we are viewing the major surface facing in toward a flexitank. FIG. 24 illustrates some of the possible positions of fasteners 208, and position of an orifice 232 in flexible bulkhead panel 206 for a discharge valve of a flexitank to protrude through. FIG. 25 illustrates a major portion of protective net or fabric 210 hanging alongside flexible panel 206, and one embodiment of fastening straps 236, that may be used to fasten fabric 210 to the inside of a container 12. Although two fastening straps 236 are illustrated, there may be more, and they may be positioned differently than illustrated. Fastening straps 236 are themselves fastened to fabric 210, such as by stitching, gluing, hook and loop fasteners, or combination of these techniques.

FIGS. 25 and 26 also illustrate an important additional feature of shipping container systems of this disclosure, the provision of one or more tail panels 234 (in this embodiment six tail panels are illustrated). Tail panels 234, which in some embodiments are comprised of material the same as that comprising flexible bulkhead panel 206 (although this is not required) serve the important function, when positioned under the rear end of a filled or partially-filled flexitank, of helping to secure the bulkhead assembly in position. Tail panels 234 do not have a set length. They may have any length which functions to help secure a bulkhead assembly and/or flexitank. In certain embodiments tail panels 234 may all be the same length, while in other embodiments they may have different lengths. For example, those nearer the center of the container may be longer than those closer to the sides of the container, and vice versa. An example length may be 12 inches, measured from flexible panel 206 to a tip of a tail panel 234. The shape of tail panels may be any shape, including, but not limited to: rectangular (including, but not limited to, square), cone-shaped, oval, circular, triangular, trapezoid, parallelogram, and the like. While they are generally planar structures to facilitate positioning under a flexitank and folding up when not in use, they may, in certain embodiments, have some degree of three-dimensional structure, although any shape that might interfere with loading, unloading, or which might serve to supply a point or edge that might cause a leak in a flexitank would be heavily discouraged. Those of skill in the art will be able to modify the flexitank materials and shape and materials of the tails to accommodate most any situation without unreasonable experimentation. In certain embodiments, the tails may include one piece of a hook and look fastener or other type of fastener, while the flexitank may include on its outside surface a mating piece. In many embodiments, all materials of the flexible panel 206, fabric 210, tail panels 234, and fastener straps 236 comprise recyclable materials, such as plastic.

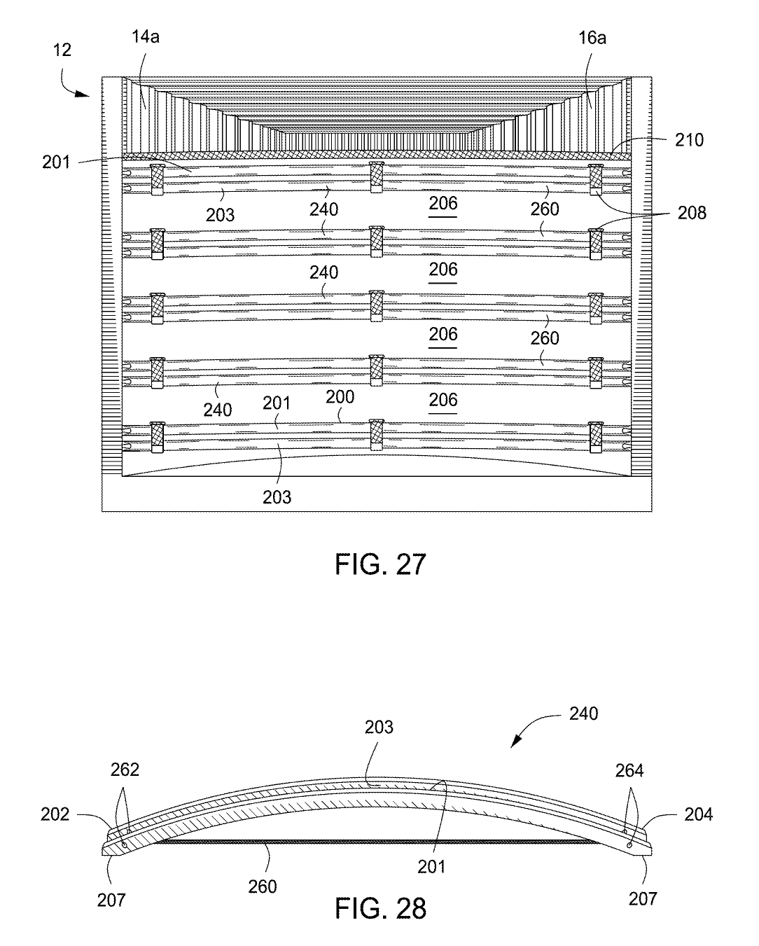

FIG. 27 is a rear end elevation view of another bulkhead assembly in accordance with disclosure having a flexible bulkhead panel 206 and a plurality of fasteners 208 illustrated in previous figures, four generally curved bulkhead bars of FIG. 28 (the top four), and one generally curved bulkhead bar of FIGS. 15-23 (near the bottom) installed in a container 12. Many alternatives may be envisioned. Alternatively, all five of the curved bulkhead bars may be as in embodiment 200; all may be embodiment 240, or any combination of those embodiments may be used. FIG. 28 is a perspective view of embodiment 240 of a generally curved bulkhead bar in accordance with the disclosure. It is identical to embodiment 200, except for the provision of a cable 260, attached by bolts and cotter pins 262, 264 through holes 205 previously illustrated in FIG. 19. Cable 260, generally of steel, although other materials may be used, is used as an additional strengthening mechanism for bulkhead assemblies and shipping container systems disclosed herein. As the bar 201,203 tends to lengthen upon exertion of a force F as depicted schematically in FIG. 19, cable 260 will tend to prevent this lengthening. In certain embodiments, this will enable less robust bulkhead bars to be used, lessening weight and cost of production.

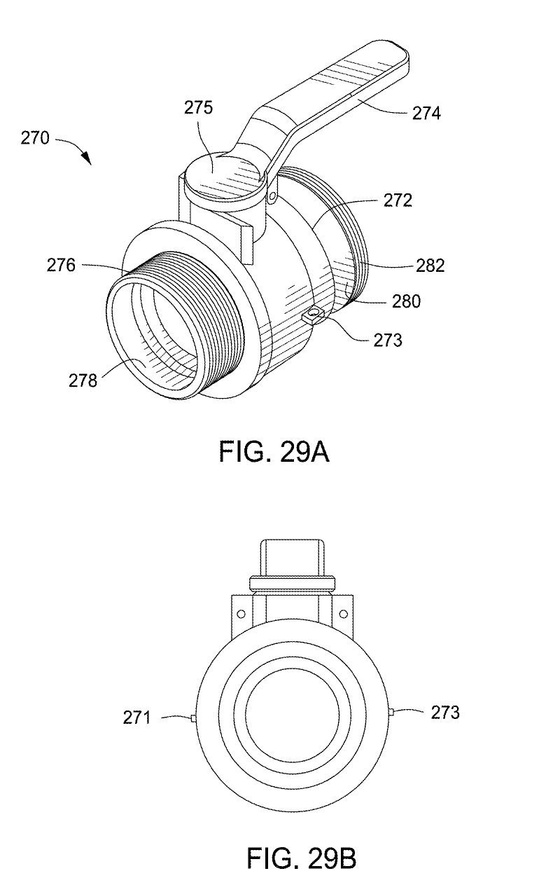

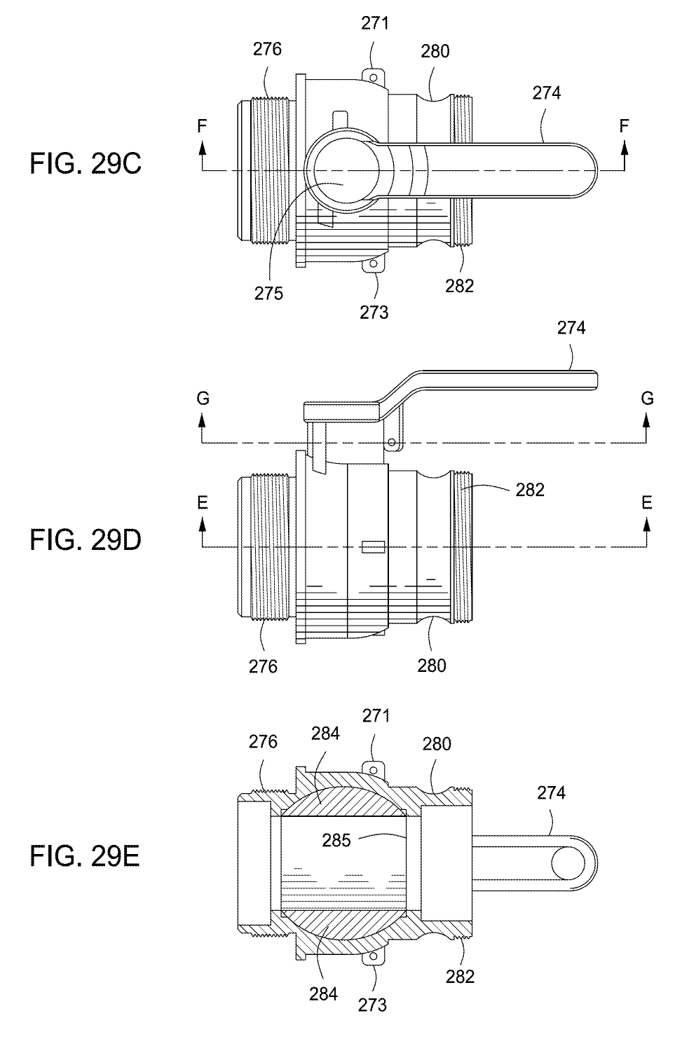

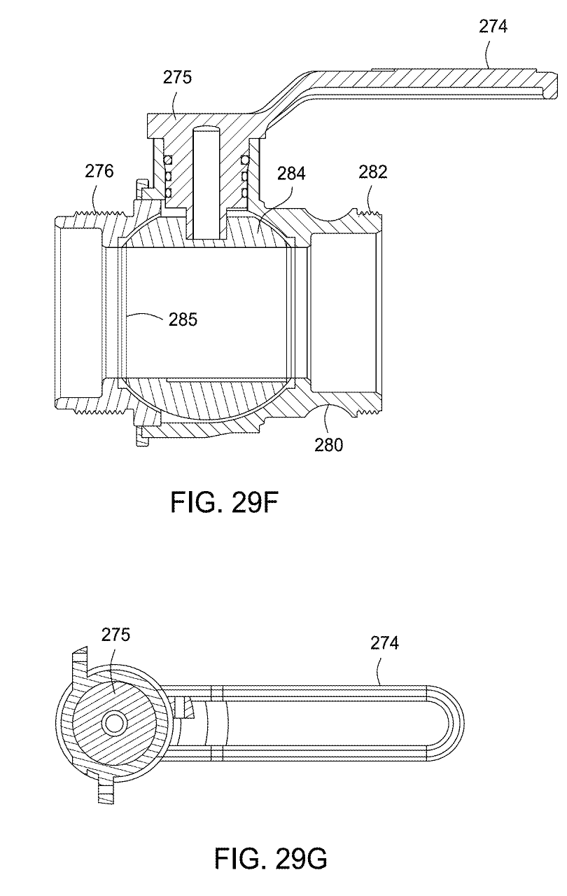

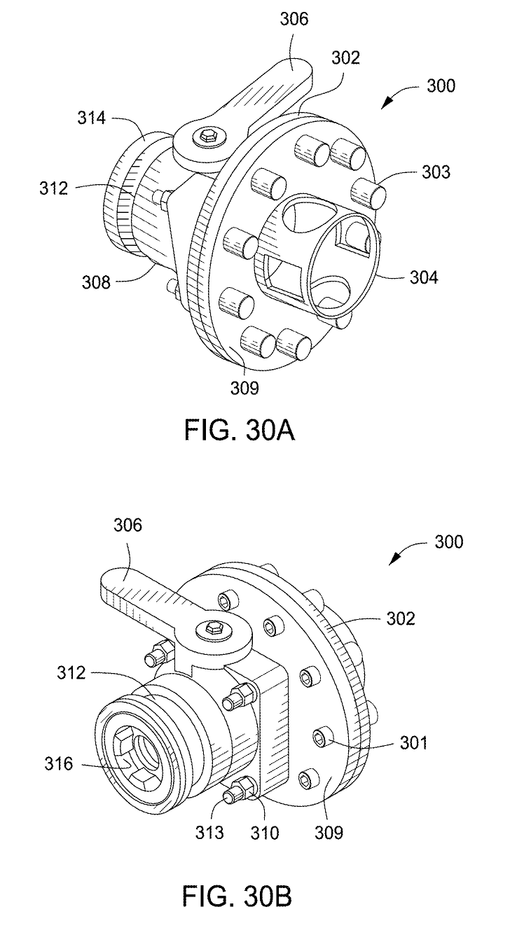

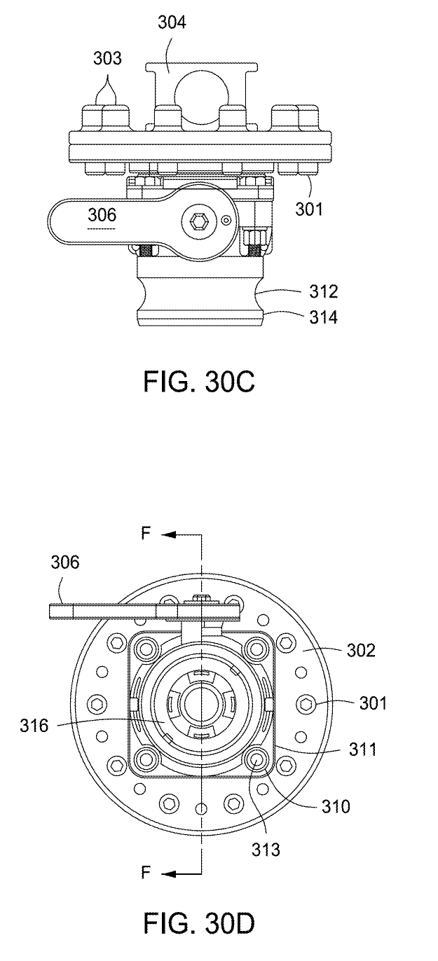

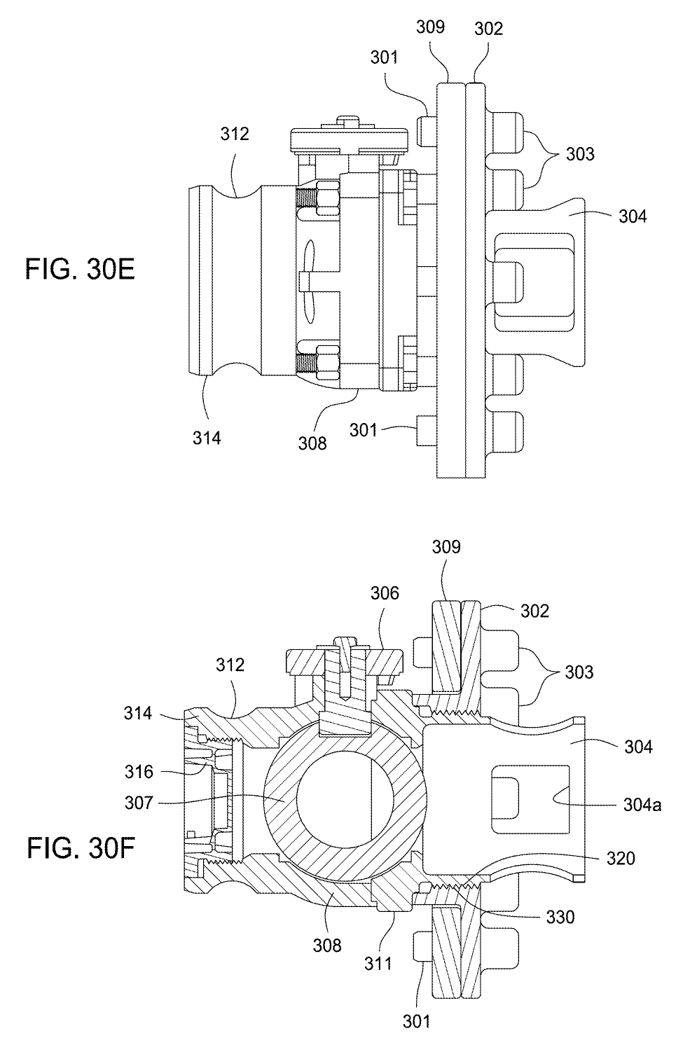

FIGS. 29A-G and 30A-F are various views of two flexitank discharge valves useful in shipping container systems in accordance with the disclosure. The valve embodiment 270 illustrated in FIGS. 29A-G is a nominal 2-inch valve, while the valve embodiment 300 illustrated in FIGS. 30A-F is a nominal 3-inch valve, measured as nominal diameter of conduits in which they are used to convey fluids and/or granular solids. Valve 270 includes a valve body 272, and a handle 274 connecting to a handle body portion 275 for turning the valve to its on and off positions. In addition, valve 270 includes both internal and external threaded surfaces 276, 278 on one end, which is the end of the valve that connects to a compression flange which in turn connects valve 270 to a flexitank, as explained more fully in relation to the valve illustrated in FIG. 30. Valve 270 also includes a quick-connect-disconnect coupling connection 280, and a threaded region 282 on its outlet end external surface. As illustrated in FIGS. 29A and 29B, valve 270 includes two side short side extensions or protrusions 271 and 273 useful for engaging with a tool (not illustrated) when screwing the valve onto a mating threaded connection of a flexitank. Extensions 271, 273 are also useful for the technician installing the valve, as the technician will know that the valve has been tightened an optimal amount of torque to reduce leaks from the valve. FIG. 29C is a top plan view of valve embodiment 270, and indicates a cross-section taken along the line F-F. This cross-sectional view is presented as FIG. 29F, and illustrates a portion 284 of the internal ball section of valve 270. Ball section 284, which is connected to handle body portion 275, rotates within a throat of valve 270, indicated at 285, when handle 274 is rotated. FIG. 29D is a side elevation view of valve 270, indicating cross-sections E-E and G-G, which are presented in FIGS. 29E and 29G, respectively. FIG. 29E illustrates another view of the ball 284 in valve throat 285.

Valve embodiment 300 of FIG. 30 is similar to valve embodiment 270 of FIG. 29. As illustrated in FIGS. 30A and 30B, valve 300 includes a handle 306, a valve body 308, a quick-connect-disconnect coupling 312, and further illustrates how a compression flange 302 may be threadedly fitted onto valves 270 and 300. Compression flange 302 includes a plurality of nuts 301 and mating threaded bolts (not illustrated) that pass through mating half-flanges 302 and 309. Half-flange 302 has a corresponding plurality of bolt extension covers 303 molded into it that essentially seal the bolts and prevent leakage of the flexitank contents out through the bolt holes of the half-flanges 302, 309. Half-flanges 302 and 309 form a compression flange, with the flexitank layers sandwiched in between. FIGS. 30A-F also illustrate an anti-suction extension 304 having the function of preventing some or all of the flexitank from exiting through the valve upon emptying the flexitank. Extension 304 includes passages 304b which allow passage of fluids and granular solids, but not large objects. A protective insert 316 is illustrated in FIGS. 30B, 30D, and 30F. This insert protects threads on the internal surface of the valve. Valve 300 also includes a square valve body portion 311, held together using four bolts 313 and corresponding nuts 310. The square shape of valve body portion 311 allows use of a tool, resembling a large square socket wrench (not illustrated), to be used to tighten the valve body onto an installed flange using threaded mating connections 320, 322, as illustrated in the cross-section F-F presented as FIG. 30F. The square body section could take other shapes; for, example, the shape could be hexagonal, in which case six bolts 313 and corresponding nuts 310 would be used. It should be understood that valve 270 of FIG. 29 could use a similar set of half-flanges to connect valve 270 to a flexitank.

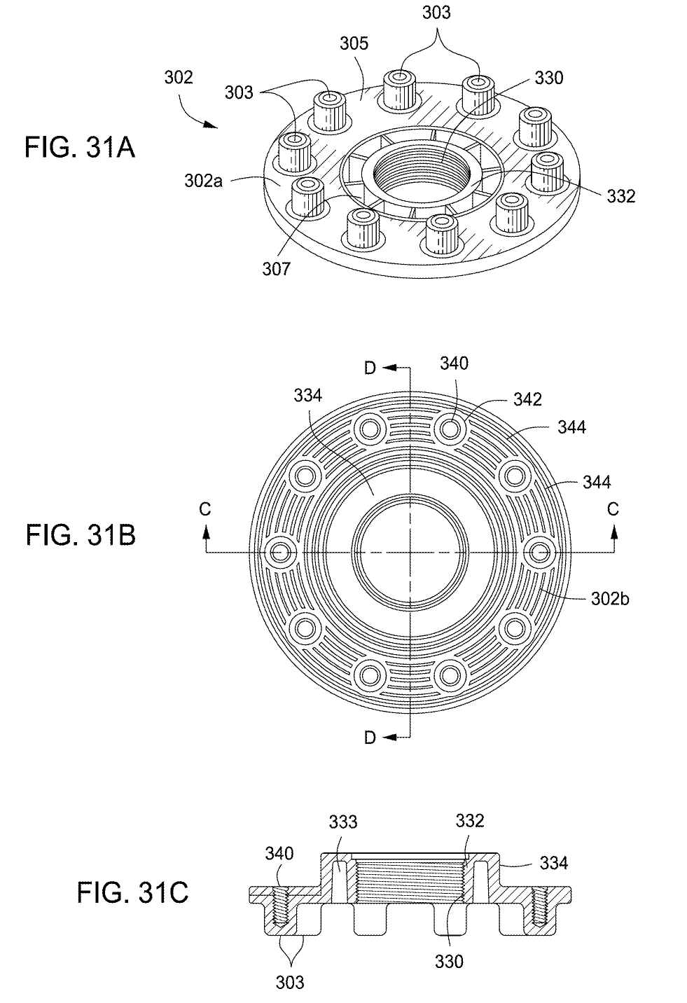

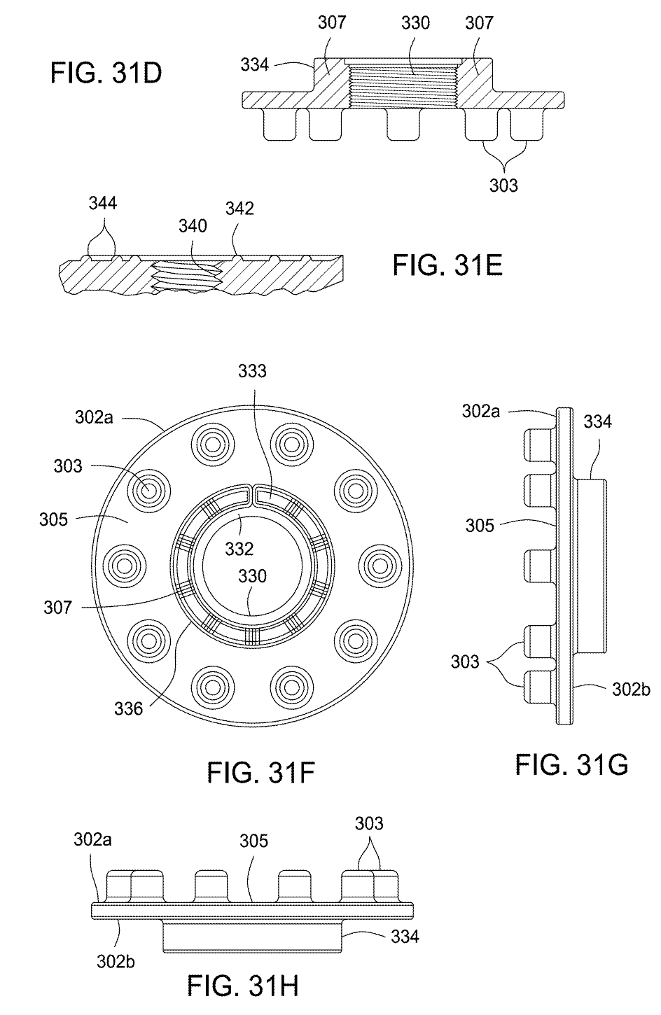

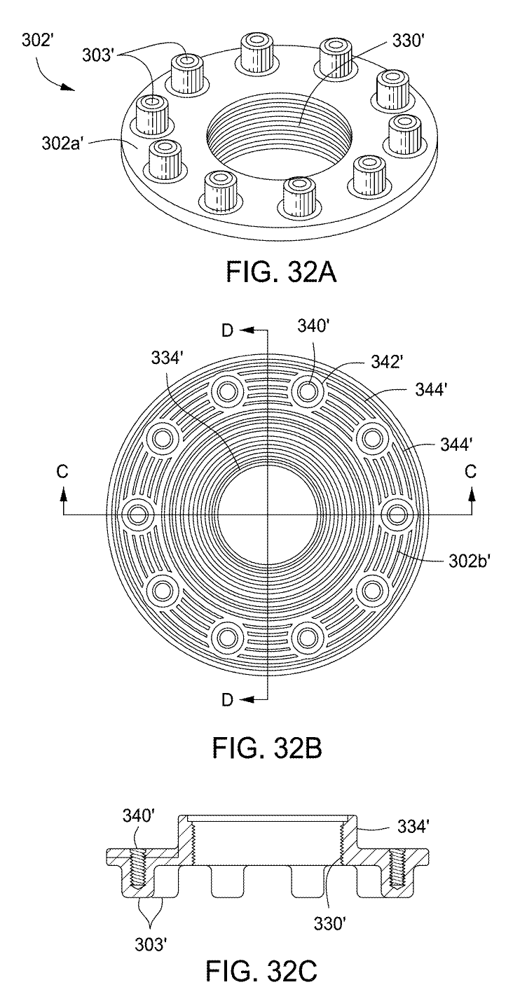

FIGS. 31A-H and 32A-I are various views of three half-flanges 302, 302′, and 302″ useful with valves 270 and 300, respectfully. As illustrated in FIG. 31A, bolt extension covers 303 may be clearly seen on 302a. Side 302a includes a substantially planar surface 305 from which the bolt extension covers 303 extend away from. Also clearly depicted is threaded central opening 330, in this embodiment supported by a molded ring 332. Molded ring 332 is in turn supported by a plurality of struts 307. The struts 307, ring 332, and molded extension 334 form chambers 333, which serve to lessen the weight of the half-flange 302 and conserve material. FIG. 31B is a plan view of side 302b of half-flange 302, and presents cross-sections C-C and D-D, which are illustrated in FIGS. 31C and 31D, respectively. FIGS. 31B and 31C and 31E illustrate threads 340 for bolt holes, as well as a series of circumferential ribs 344 and circular ribs 342 around each bolt hole. FIG. 31E is a more detailed view of the threads of one of the bolt holes, as well as ribs 342 and 344. Ribs 342 and 344 substantially prevent leakage from the flexitank in a surprisingly effective manner. Ribs 344 act to constrain flexitanks layers between the ribs 344 when the half-flanges 302 and 309 are compressed together. As a second barrier, even if a fluid should find its way from the flexitank into spaces between ribs 344, ribs 342 act as a further barrier dam to prevent the fluid from leaking out through the bolt holes.

FIGS. 32A-H illustrate another half-flange 302′ which has many features similar to half-flange 302 illustrated in FIGS. 31A-H. As illustrated in FIG. 32A, bolt extension covers 303′ may be clearly seen on 302a′. Side 302a′ includes a substantially planar surface 305′ from which the bolt extension covers 303′ extend away from. Also clearly depicted is threaded central opening 330′. FIG. 32B is a plan view of side 302b′ of half-flange 302′, and presents cross-sections C-C and D-D, which are illustrated in FIGS. 32C and 32D, respectively. FIGS. 32B, 32C and 32E illustrate threads 340′ for bolt holes, as well as a series of circumferential ribs 344′ and circular ribs 342′ around each bolt hole. FIG. 31E is a more detailed view of the threads of one of the bolt holes, as well as ribs 342′ and 344′. Ribs 342′ and 344′ substantially prevent leakage from the flexitank in a surprisingly effective manner, as explained previously for ribs 342 and 344 in FIG. 31.

FIG. 32I illustrates a perspective view of half flange embodiment 302″, having a different anti-suction construction than illustrated in FIG. 30. The anti-suction component 346 of embodiment 302″ illustrated in FIG. 32I comprises four legs 347 substantially perpendicularly arranged with a common center, the legs substantially in a plane parallel with the plane of half flange face 302a′, each leg 347 molded into and integral with half-flange face 302a′. Those skilled in the art will recognize other variations, such as six-leg structures with all legs having common centers, structures having one or more parallel beams, structures having intersecting beams, and the like, and all of these variations are deemed within this disclosure.

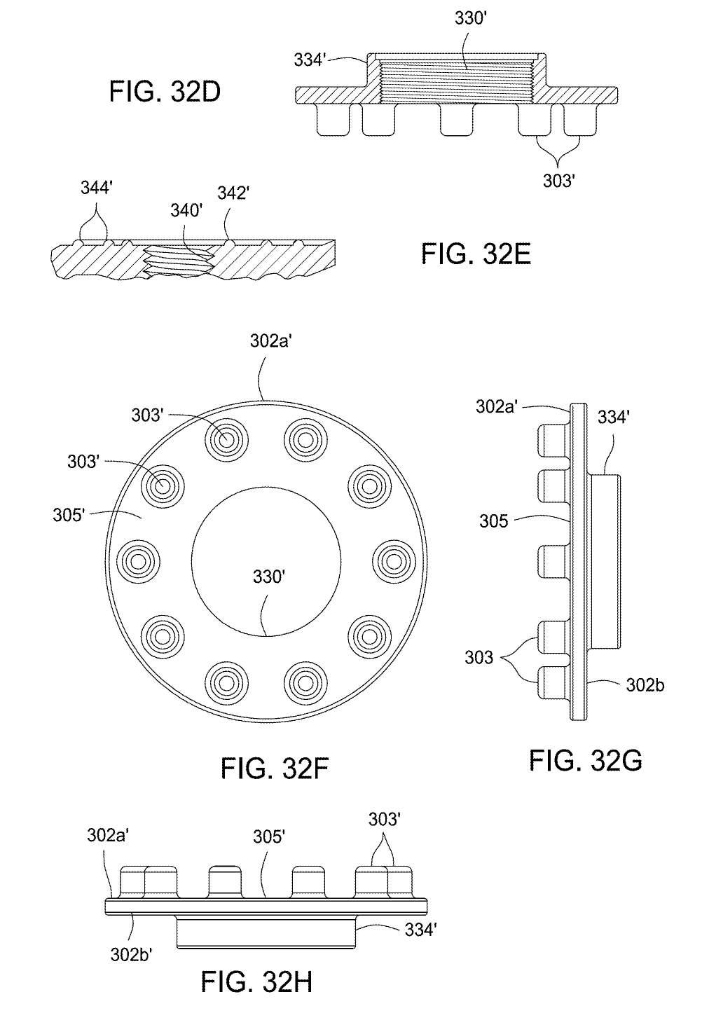

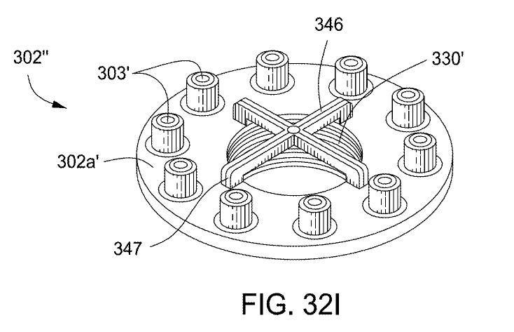

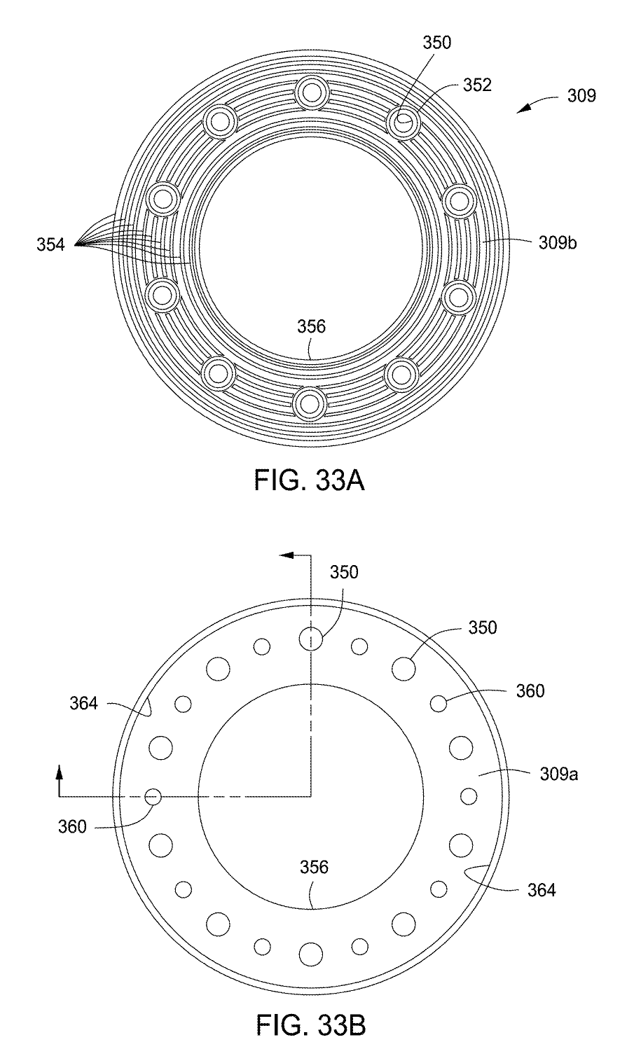

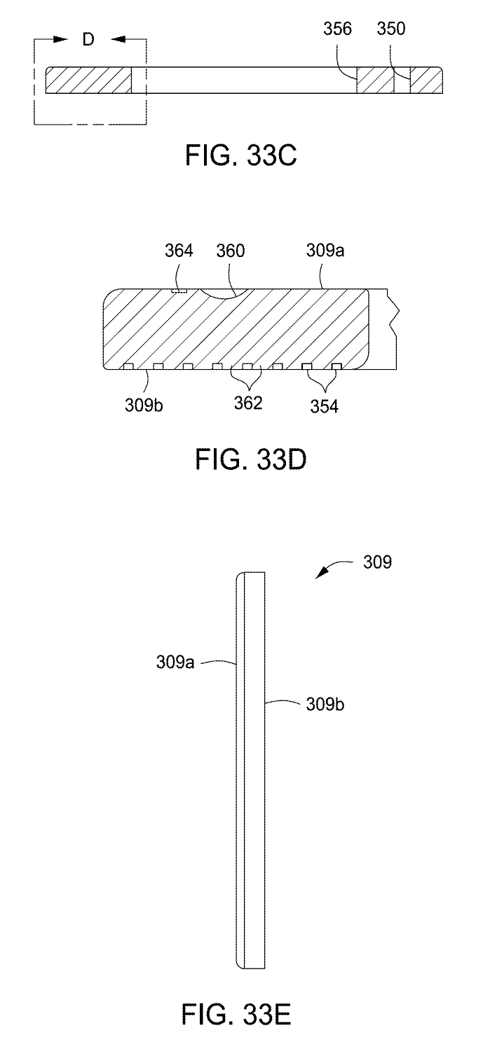

FIG. 33A-E are various views of a half-flange or compression plate 309 useful with the half-flanges 302 and 302′ illustrated in FIGS. 31 and 32. Half flange 309 has a face 309b comprising a plurality of valleys 354 which mesh with corresponding ribs 344 in half-flange 302 (FIG. 31) and with ribs 344′ in half-flange 302′ (FIG. 32). Half flange 309 also comprises ten threaded bolt holes 350, as well as a valley 352 that meshes with rib 342 in FIG. 31 and with rib 342′ in FIG. 32. Half flange 309 also comprises a central through passage 356. Other major surface 309a of half flange 309 may optionally include recessed lettering 364 as illustrated in FIG. 33B, which also illustrates depressions 360 formed by gates in the injection molding process. Depressions 360 are not required in shipping container systems of this disclosure.

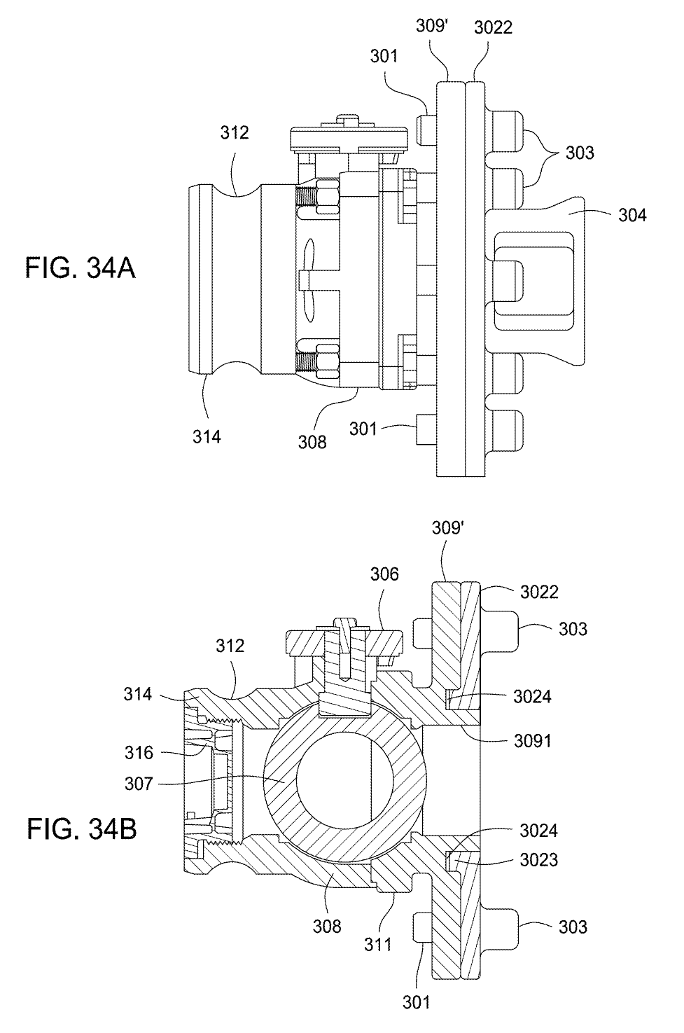

FIGS. 34A and B are side elevation and cross-sectional views, respectively, of another discharge valve useful in shipping container systems of this disclosure. The valve illustrated in FIGS. 34A and B has similar features to the valve illustrated alf flange 309′ in FIG. 30A-F. However, whereas the valve in FIGS. 30A-F requires a two piece compression flange 302, 309, in the embodiment illustrated in FIGS. 34A and B one half of the flange, 309′, is integral with the valve body 308, 311. Half flange 309′ comprises a cylindrical male extension 3091, while half flange 3022 comprises a female cylindrical extension 3023 extending in mating relationship to male extension 3091. It should be understood that the male and female extensions could be interchanged on the half-flanges, that is, the male extension could be molded into half flange 3022, with the female extension molded into half flange 309′. In the embodiment illustrated, a gasket 3024 is provided to provide a seal. The embodiments discussed in this paragraph are important advances, as they eliminate screwed fitting 320, 330 illustrated in the embodiment illustrated in FIGS. 30A-F, thus eliminating a potential leak source. Whenever there is a screwed fitting, personnel may fail to properly align the threads of the fitting and try to tight the screwed fitting anyway, which has detrimental effects on the tightness of the screwed fitting.

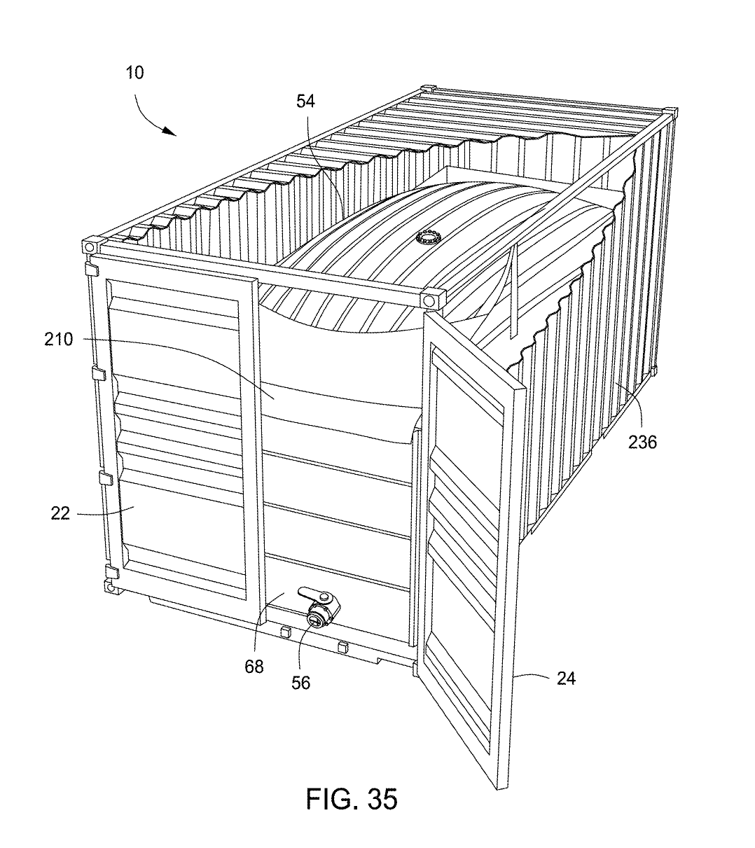

FIGS. 35, 36, and 37 are perspective views, with portions cut away, of three shipping container systems in accordance with the disclosure. Shipping container 10 illustrated schematically in FIG. 35 illustrates a bulkhead assembly known under assignee's trade designation BIG RED RIGID BULKHEAD™, and is essentially the bulkhead assembly 68 illustrated in FIGS. 1-14, utilizing two vertical braces 72 and four bulkhead panels 90. Also illustrated is one fastener strap 236 of a protective fabric 210 connected to the inside of container 10. The bulkhead assembly illustrated in shipping container system 10 is designed to meet the high performance demands and safety regulations of railroad authorities in dedicated traffic flows of 20 or 40 foot containers, is rigid, reusable and returnable, and installs in less than 5 minutes, with no tools required.

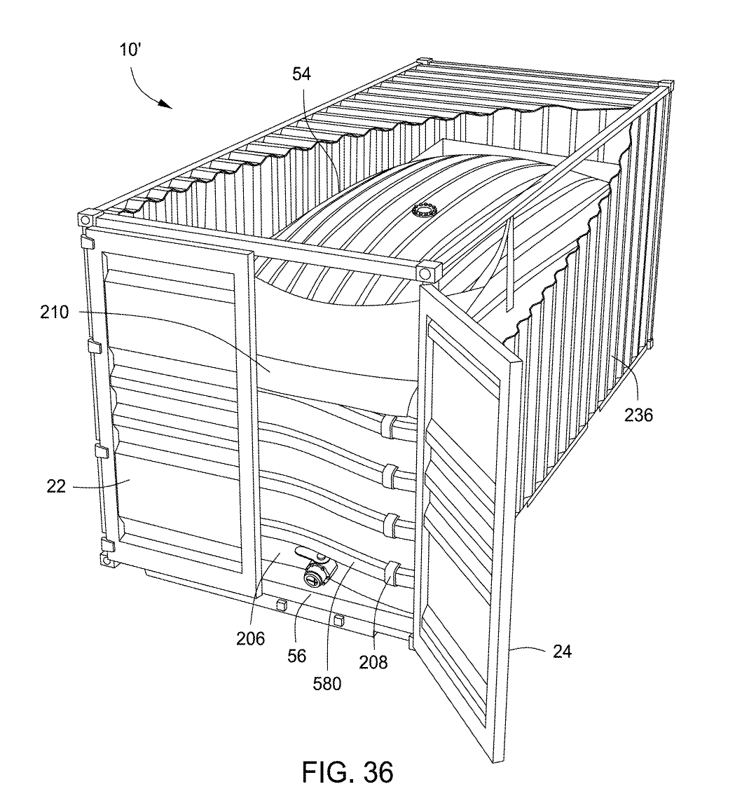

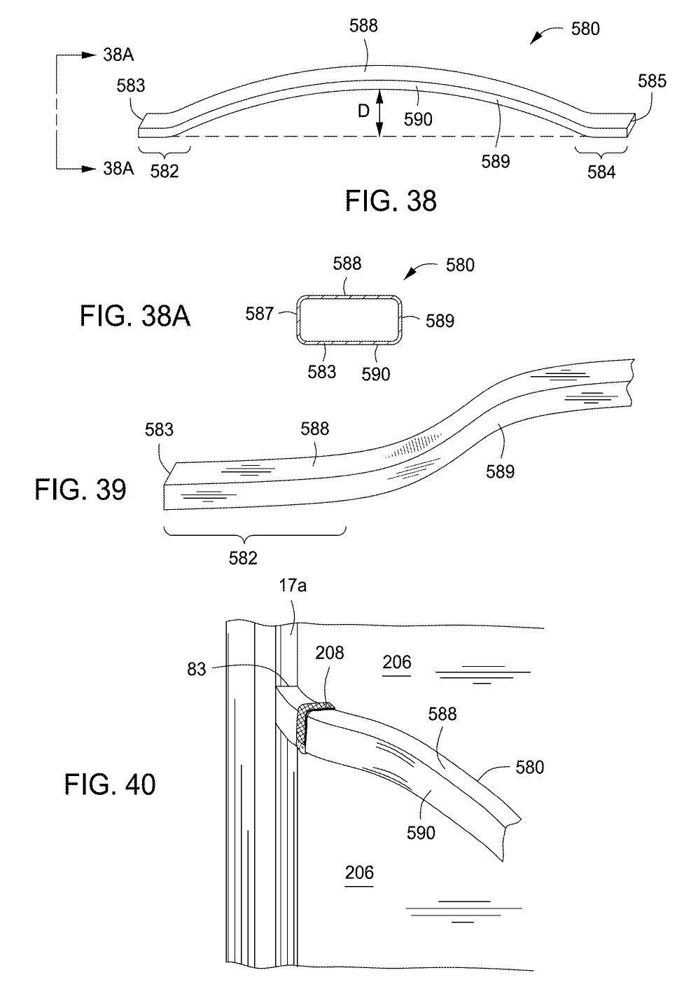

The shipping container system 10′ illustrated in FIG. 36 employs a bulkhead assembly known under assignee's trade designation BIG RED SWEPT-BAR BULKHEAD™ employing four “plain” generally curved bulkhead bars 580 such as illustrated in FIGS. 38-40. It will be understood that any swept-bar, generally curved bulkhead bars, such as embodiments 200, 240, and variations thereof could be used just as well. A flexible bulkhead panel 206 is also used, along with a plurality of hook and loop fasteners 208 to fasten the swept bulkhead bars 580 to flexible bulkhead panel 206. It may be seen that using such a bulkhead assembly recesses valve 56 away from door 24 when it is closed, thus helping to reduce leakage from the valve due to jarring or bumping of the valve by door 24. The bulkhead assembly illustrated in shipping container system 10′ is designed to meet the high performance demands and safety regulations of railroad authorities worldwide, and is easy to install with minimal assembly time.

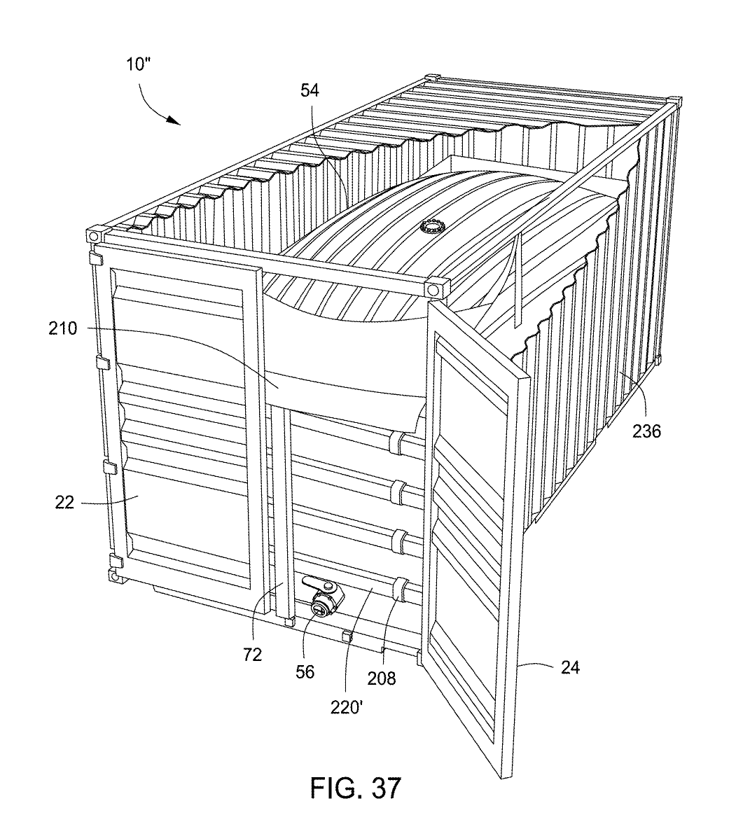

The shipping container system 10″ illustrated in FIG. 37 employs a bulkhead assembly known under assignee's trade designation BIG RED STRAIGHT-BAR BULKHEAD™ employing four “plain” substantially straight bulkhead bars. These bulkhead bars are essentially the same as those illustrated in FIGS. 38-40, except that instead of being straight only in the end regions, the bars are substantially straight for their entire length, essentially perpendicular to the container side walls. Using such a bulkhead assembly may require a central vertical brace 72. The bulkhead assembly illustrated in shipping container system 10″ is especially useful in road and sea transportation, is easy to install with minimal installation time, and may serve as a single-use bulkhead.

The protective fabric 210 and fasteners 236 illustrated in FIGS. 35-37 are available from assignee under their trade designation BIG RED SURGE WING™, and serves to secure and protect flexitank 54, helps prevent “flexitank rollover” (the tendency of a flexitank to roll over the top of the bulkhead assembly), and helps control liquid dynamics in the flexitank.

FIGS. 38 and 39 are perspective views, and FIG. 38A is an end elevation, of another generally curved bulkhead bar 580 useful in bulkhead assemblies disclosed herein. Generally curved bulkhead bar 580 is termed a “plain” bar, as it has a simple construction, typically a one-piece extruded or rolled steel piece formed into hollow rectangular-section beam, as illustrated in end elevation in FIG. 38A. In this embodiment, rather than having crimps on the ends in order to fit the bars into the lashing channels of a container, the end regions 582 and 584 are relatively straight and essentially perpendicular to container vertical walls 14 and 16. The length of straight sections 582, 584 may vary, but generally range from about 3 inches to about 12 inches or more.

FIG. 40 is a perspective view of one end of generally curved bulkhead bar 580 of FIGS. 38 and 39 installed in lashing channel 17a of a container. As with previous embodiments, flexible bulkhead panel 206 is fastened to bar 580 using fasteners 208 (only one being illustrated in FIG. 40). Generally curved bulkhead bar 580 comprises two major surfaces 588, 590 connected by two narrower side sections 587, 589. Major surface 588 is adjacent flexible bulkhead panel 206 when installed. The distance D indicated in FIG. 38 may have the same length more or less as disclosed previously for generally curved bulkhead bar embodiments 200 and 240. The advantages of embodiment 580 include simpler manufacturing and lower cost, while disadvantages may include a lower strength than embodiments 200 and 240.

Although only a few exemplary embodiments have been described in detail above, those skilled in the art will readily appreciate that many modifications are possible in the exemplary embodiments without materially departing from the novel teachings and advantages of shipping container systems, bulkhead assemblies, valves, flanges, and methods described herein. Accordingly, all such modifications are intended to be included within the scope of this disclosure as defined in the following claims. Although Applicants may not have a claim in this document to every aspect of the disclosure, Applicants have the specific intent to file claims to cover all aspects disclosed herein, either in amendments to this application, or in one or more continuation and/or divisional applications. In the claims, no clauses are intended to be in the means-plus-function format allowed by 35 U.S.C. §112, paragraph 6, unless “means for” is explicitly recited together with an associated function without any structure being recited. “Means for” clauses are intended to cover the structures described herein as performing the recited function and not only structural equivalents, but also equivalent structures.

1. A shipping container system comprising:
a rigid shipping container,
a flexitank disposed within the rigid shipping container and a bulkhead assembly interposed between the flexitank and an open rear end of the rigid shipping container or doors of the shipping container hingedly attached to the rear end when the doors are in a closed position;
wherein the bulkhead assembly comprises two substantially vertical braces, at least a portion of which are disposed in squared lashing channels of opposing side walls of the container, and at least one bulkhead panel that is substantially horizontally disposed between the vertical braces.

2. The shipping container system of claim 1 further comprising an intermediate bulkhead assembly.

3. The shipping container system of claim 1 wherein the bulkhead assembly comprises three or more bulkhead panels substantially horizontally disposed between the vertical braces.

4. The shipping container system of claim 3 wherein the bulkhead assembly comprises an upper bulkhead panel, one or more intermediate bulkhead panels, and a lower bulkhead panel.

5. The shipping container system of claim 1 comprising a flexible sleeve comprising a flexible substantially planar composite member.

6. The shipping container system of claim 5 wherein the flexible sleeve comprises at least one absorbent layer.

7. The shipping container system of claim 5 wherein the flexible sleeve comprises two or more sheets laminated together.

8. The shipping container system of claim 1 wherein the rigid shipping container comprises a floor, a first side wall with a first side wall inner surface, a second side wall with a second side wall inner surface and an open end.

9. The shipping container system of claim 1 comprising one or more gas-filled flexible containers disposed against an upper surface of the flexitank.

10. The shipping container system of claim 1 wherein the substantially vertical braces each comprise a single primary brace member comprising a C-beam having an outer surface facing toward the container doors, and the portions of the vertical braces disposed in the lashing channels comprise two or more secondary brace members attached to the outer surface of the C-beam.

11. The shipping container system of claim 10 wherein the secondary brace members comprise support boxes spaced at irregular intervals and fitting into the squared lashing channels.

12. The shipping container system of claim 10 wherein the primary brace member comprises
a vertical channel defined by four elongated sub-surfaces forming an overall inner surface of the brace, which define a vertical channel for each brace,
two elongated sub-members providing two sub-surfaces that face one another, not strictly coplanar, but canted with respect to one another;
an intermediate member joining the two elongated sub-members, the intermediate member composed of two intermediate sub-members which provide two sub-surfaces;
the vertical brace capable of an open, unlocked position, and a closed, locked position, primary brace member providing the vertical channel on the side that is defined by the four elongated sub-surfaces of the sub-members,
one end of each horizontally disposed bulkhead panel fitting into the vertical channel, and
a distance between an outer edge of the two elongated sub-members being sufficient to accommodate the width of the bulkhead panels, the two elongated sub-members slanting outwards in the direction of the adjoining intermediate members so that the distance between the adjoining edges of the two elongated sub-members is greater than the distance between the outer edges of the two elongated sub-members, allowing shifting the vertical brace from said open, unlocked position, to said closed, locked position, with the inside surface of one of the two elongated sub-members clamping against the inner surface of the bulkhead panel.

13. The shipping container system of claim 12 wherein the two intermediate sub-members comprise first and second outer surfaces that are canted with respect to one another, namely, they lie in first and second planes, the first plane defined by the outer surface of a first intermediate section, and the second plane defined by the outer surface of a second, larger intermediate section, such that when the brace is in said open position, the outside surface of the second, larger intermediate section abuts against one of the inside surfaces of the rigid container, and when the brace is shifted to said closed position after the bulkhead panels are installed, the brace rotates forward (toward the doors of the container) and the outside surface of the first intermediate section abuts against that same inside surface of the container.

14. The shipping container system of claim 13 wherein the secondary brace members are affixed to an outer one of the two elongated sub-members, the secondary brace member comprising a protrusion fitting into the square lashing channel, the protrusion comprising a first, outer-directed surface which abuts against the outermost surface of lashing channel, and thereby provides support against movement of the bulkhead panels toward the doors, the protrusion comprising a second surface which, when the bulkhead assembly is in said closed, locked position, can abut and be in physical contact with and against the surface of the intermediate portion of the lashing channel, i.e., the surface of the lashing channel that is parallel with the length of the container and perpendicular with the open end and/or the closed doors and forms the bottom of the lashing channel.

15. The shipping container system of claim 14 wherein the secondary brace member comprises a third surface that is not in physical contact with the container when the brace is in the open position, but when the brace rolls to a closed position, the third surface abuts against the side of the container and thus prevents the brace from rolling forward.

16. The shipping container system of claim 1 wherein the at least one bulkhead panel comprises:
a lower bulkhead panel, an upper bulkhead panel, and one or more intermediate bulkhead panels, the lower bulkhead panel comprising a top surface, which supports the one or more intermediate bulkhead panels, a bottom surface, which rests on a rigid container floor, and an inner surface lying in the same plane as inner surfaces of the upper and intermediate bulkhead panels to form a single bulkhead wall surface, and an outer surface, which is set back away from outer edges of the top and bottom surfaces, and
an aperture in the lower bulkhead panel occupying a plane that is separated from a plane defined by an inner surface of the lashing channel closest to the rear wall by at least 2 inches.

17. The shipping container system of claim 2 wherein the intermediate bulkhead assembly comprises two vertical braces, each brace comprising:
a vertical channel defined by four elongated sub-surfaces forming an overall inner surface of the brace, which define a vertical channel for each brace,
two elongated sub-members providing two sub-surfaces that face one another, not strictly coplanar, but canted with respect to one another;
an intermediate member joining the two elongated sub-members, the intermediate member composed of two intermediate sub-members which provide two sub-surfaces;
the vertical brace capable of an open, unlocked position, and a closed, locked position, primary brace member providing the vertical channel on the side that is defined by the four elongated sub-surfaces of the sub-members,
one end of each horizontally disposed bulkhead panel fitting into the vertical channel, and
a distance between an outer edge of the two elongated sub-members being sufficient to accommodate the width of the bulkhead panels, the two elongated sub-members slanting outwards in the direction of the adjoining intermediate members so that the distance between the adjoining edges of the two elongated sub-members is greater than the distance between the outer edges of the two elongated sub-members, allowing shifting the vertical brace from said open, unlocked position, to said closed, locked position, with the inside surface of one of the two elongated sub-members clamping against the inner surface of the bulkhead panel.

18. The shipping container system of claim 17 comprises a pair of retainers and pins or bolts securing the braces to the retainers, wherein each retainer is elongated and comprises at least three different elongated outer sub-surfaces which lie in different planes, and which fit against in abutting relation to the inner sub-surfaces of the container wall lazy corrugations, each retainer also comprising a structure that includes an aperture or opening to receive a bolt or pin, so that each brace is rotatably affixed to the retainer.

19. A shipping container system comprising:
a rigid shipping container,
a flexitank disposed within the rigid shipping container and a bulkhead assembly interposed between the flexitank and an open end of the rigid shipping container or doors of the shipping container when the doors are in a closed position;
wherein the bulkhead assembly comprises one or more generally curved, arc-shaped, or swept bulkhead bars, each of which is substantially horizontally disposed between side walls of the container, each bar having first and second ends, each end removably inserted into a lashing channel of the container, and one or more flexible bulkhead panels disposed between the bars and the flexitank, the flexible panels comprising a plurality of fasteners fastening the flexible bulkhead panels adjacent to the swept bars.

20. The shipping container system of claim 19 wherein at least one of the swept bulkhead bars comprises a B-beam shape, and each end has crimps in the lobes of the B so that the ends fit into the lashing channels.

21. The shipping container system of claim 20 wherein at least one of the swept bulkhead bars comprises a cable attached substantially at the ends of the B-beam and extending the chord length of the swept bar.

22. The shipping container system of claim 19 wherein at least one of the swept bars is a bar comprising a hollow rectangular beam having first and second end regions, the end regions straightened so that the ends fit in the lashing channels without crimping.

23. The shipping container system of claim 19 wherein the fasteners comprise hook and loop fasteners.

24. The shipping container system of claim 19 further comprising an intermediate bulkhead assembly.

25. The shipping container system of claim 19 comprising a flexible sleeve comprising a flexible substantially planar composite member.

26. The shipping container system of claim 25 wherein the flexible sleeve comprises at least one absorbent layer.

27. The shipping container system of claim 25 wherein the flexible sleeve comprises two or more sheets laminated together.

28. The shipping container system of claim 19 wherein the rigid shipping container comprises a floor, a first side wall with a first side wall inner surface, a second side wall with a second side wall inner surface and an open end.

29. The shipping container system of claim 19 comprising one or more gas-filled flexible containers disposed against an upper surface of the flexitank.

30. A shipping container system comprising:
a rigid shipping container,
a flexitank disposed within the rigid shipping container and a bulkhead assembly interposed between the flexitank and an open end of the rigid shipping container or doors of the shipping container when the doors are in a closed position;
wherein the bulkhead assembly comprises one or more generally straight bulkhead bars, each of which is substantially horizontally disposed between side walls of the container, each bar having first and second ends, each end removably inserted into a lashing channel of the container, and one or more flexible bulkhead panels disposed between the bars and the flexitank, the flexible panels comprising a plurality of fasteners fastening the flexible bulkhead panels adjacent to the straight bars.

31. The shipping container system of claim 30 wherein the fasteners comprise hook and loop fasteners.

32. The shipping container system of claim 30 further comprising an intermediate bulkhead assembly.

33. The shipping container system of claim 30 comprising a flexible sleeve comprising a flexible substantially planar composite member.

34. The shipping container system of claim 33 wherein the flexible sleeve comprises at least one absorbent layer.

35. The shipping container system of claim 33 wherein the flexible sleeve comprises two or more sheets laminated together.

36. The shipping container system of claim 30 wherein the rigid shipping container comprises a floor, a first side wall with a first side wall inner surface, a second side wall with a second side wall inner surface and an open end.

37. The shipping container system of claim 30 comprising one or more gas-filled flexible containers disposed against an upper surface of the flexitank.

38. A bulkhead bar comprising a substantially arc-shaped, swept-shaped or bow-shaped piece of hollow steel having first and second ends and having a cord length substantially equal to a straight bulkhead bar, the shaped piece of steel having its ends modified so that the ends fit into a square lashing channel of a container adjacent the doors of the container.

39. The bulkhead bar of claim 38 wherein the shaped piece of hollow steel comprises a B-beam, where lobes of the B-beam are on a concave side of the bar, and the ends are modified by crimps.

40. The bulkhead bar of claim 39 comprising a cable connected substantially near each end of the swept bar and spanning the cord length.

41. The bulkhead bar of claim 38 comprising one or more strengthening ribs in the convex surface of the bar.

42. The bulkhead bar of claim 38 wherein the shaped hollow piece of steel is a plain hollow rectangular tube which is curved except at both end regions, which are straight so that they fit into lashing channels of a container without having to be modified at the ends.

43. A bulkhead assembly for use in a shipping container, the bulkhead assembly comprising two or more bulkhead bars selected from the group consisting of:
a) a bulkhead bar comprising a substantially arc-shaped, swept-shaped or bow-shaped piece of hollow steel having first and second ends and having a cord length substantially equal to a straight bulkhead bar, the shaped piece of steel having its ends modified so that the ends fit into a square lashing channel of a container adjacent doors of the container;
b) the bulkhead bar of part (a) wherein the shaped piece of hollow steel comprises a B-beam, where lobes of the B-beam are on a concave side of the bar;
c) the bulkhead bar of part (b) comprising a cable connected substantially near each end of the swept bar and spanning the cord length;
d) the bulkhead bar of part (a) comprising one or more strengthening ribs in the convex surface of the bar; and
e) the bulkhead bar of part (a) wherein the shaped hollow piece of steel is a plain hollow rectangular tube which is curved except at both end regions, which are straight so that they fit into lashing channels of a container without having to be modified at the ends,
and comprising one or more flexible bulkhead panels, the flexible panels comprising a plurality of fasteners fastening the flexible bulkhead panels adjacent to the bulkhead bars.

44. The bulkhead assembly of claim 43 wherein the flexible bulkhead panels comprise one or more tail panels attached to a bottom of the flexible bulkhead panel, the tail panels positionable under the rear end of a filled or partially-filled flexitank in a shipping container system.

45. A combination valve and compression flange useful as a discharge valve for a flexitank, comprising:
a valve body defining a throat for passage of fluids, slurries or granular solids,
a handle rotatably connected to the valve body,
a first nozzle extending from the valve body comprising a quick-connect-disconnect coupling and internal and external threads,
a second nozzle extending from the valve body in a direction opposite the first nozzle and comprising external threads,
and a compression flange fitted externally onto the second nozzle, the compression flange comprising mating first and second half-flanges and a plurality of nuts and mating threaded bolts that pass through bolt holes of the mating half-flanges of the compression flange, the second half flange comprising a corresponding plurality of bolt extension covers molded into it that essentially seal the bolts and prevent leakage of fluid contents out through the bolt holes of the half-flanges, the second half flange also comprising a central passage with threads mating the external threads of the second nozzle.

46. The valve of claim 45 comprising an anti-suction device connected to the second nozzle of the second half flange to minimize or prevent a portion or all of a flexitank to which the valve is attached from being sucked out through the valve during off-loading of the flexitank, the anti-suction device comprising extensions extending aft of the second half flange.

47. The valve of claim 45 comprising an insert threadably connected to the internal threads of the first nozzle to minimize or prevent damage to the internal threads, the insert comprising passages which allow passage of fluids, but not large solid objects.

48. The valve of claim 45, wherein the first and second half flanges comprise at least one set of mating circumferential ribs, and at least one substantially circular rib around each bolt hole.

49. A combination valve and compression flange useful as a discharge valve for a flexitank, comprising:
a valve body defining a throat for passage of fluids, slurries or granular solids,
a handle rotatably connected to the valve body,
a first nozzle extending from the valve body comprising a quick-connect-disconnect coupling and internal and external threads,
a second nozzle extending from the valve body in a direction opposite the first nozzle, the second nozzle comprising a cylindrical male extension devoid of threads,
and a compression flange fitted externally onto the second nozzle, the compression flange comprising mating first and second half-flanges and a plurality of nuts and mating threaded bolts that pass through bolt holes of the mating half-flanges of the compression flange, the first half flange integral with the valve body and second nozzle, the second half flange comprising a corresponding plurality of bolt extension covers molded into it that essentially seal the bolts and prevent leakage of fluid contents out through the bolt holes of the half-flanges, the second half flange also comprising a central passage and a cylindrical female portion devoid of threads and having an internal diameter only slightly larger than an external diameter of the cylindrical male extension of the second nozzle to which it sealingly engages.

50. The valve of claim 49 comprising an anti-suction device connected to the second nozzle of the second half flange to minimize or prevent a portion or all of a flexitank to which the valve is attached from being sucked out through the valve during off-loading of the flexitank, the anti-suction device comprising extensions extending aft of the second half flange.

51. The valve of claim 49 comprising an insert threadably connected to the internal threads of the first nozzle to minimize or prevent damage to the internal threads, the insert comprising passages which allow passage of fluids, but not large solid objects.
